(19) United States
(12) Patent Application Publication
(10) Pub. No.: US 2024/0362047 A1
(43) Pub. Date: Oct. 31, 2024

(54) EMULATED NETWORK ENVIRONMENT GENERATION METHODS AND SYSTEMS FOR CYBERWARFARE TRAINING REALISM

(71) Applicant: CDW LLC, Vernon Hill, IL (US)

(72) Inventors: Marty Spain, Indian Head, MD (US); Peter Joseph Dunn, Crestview, FL (US)

(21) Appl. No.: 18/139,092

(22) Filed: Apr. 25, 2023

(51) Int. Cl. G06F 9/455; G06F 21/56

(52) U.S. Cl. CPC G06F 9/45558; G06F 21/56; G06F 2009/45562; G06F 2009/45595

(57) ABSTRACT

A method includes receiving historical Internet Protocol packet data; processing the historical Internet Protocol Packet data using a trained machine learning model to generate a plurality of virtual machines; and instantiating the plurality of virtual machines. A computing system includes a processor; a memory having stored thereon computer-executable instructions that, when executed by the processor, cause the computing system to: receive historical Internet Protocol packet data; process the historical Internet Protocol Packet data using a trained machine learning model to generate a plurality of virtual machines; and instantiate the plurality of virtual machines. A non-transitory computer-readable medium includes computer-executable instructions that, when executed by the one or more processors, cause a computer to: receive historical Internet Protocol packet data; process the historical Internet Protocol Packet data using a trained machine learning model to generate a plurality of virtual machines; and instantiate the plurality of virtual machines.

### TECHNICAL FIELD

The present disclosure is directed to improvements related to emulated network environment generation, and more particularly, to methods and systems for generating realistic cyberwarfare network environments for enhanced cyberwarfare training realism.

### BACKGROUND

Teaching cyberwarfare to students poses several challenges due to its technical complexity, the limited availability of real-world scenarios, the rapidly evolving landscape, ethical concerns around offensive operations, and security risks. Instructors need a thorough understanding of the latest tools, techniques, and tactics used by cyber attackers to convey it effectively to students. It can be difficult to recreate real-world cyberattack scenarios in a classroom environment, and training materials and techniques must be updated regularly to keep up with the latest developments. Cyberwarfare training is regularly conducted in isolated training environments to limit damage to real-world computer systems.

However, isolated environments may not accurately reflect real-world scenarios. Instructors must carefully design the isolated environment to simulate real-world conditions as closely as possible, but this can be difficult to achieve. As a result, students may not be fully prepared for the complexities and nuances of real-world cyberattacks. Moreover, isolated environments can limit students' ability to develop their skills in a practical, hands-on manner. Cyberwarfare requires a high degree of technical proficiency, which can only be acquired through extensive practice and experimentation. In conventional isolated environments, students may not have the opportunity to practice their skills in real-world scenarios, limiting their ability to develop their abilities.

Because conventional isolated systems cannot fully replicate the complexity and nuances of real-world systems, students may have access to limited resources, which can impact their ability to understand large-scale attacks or observe the impact of their actions on complex systems. Additionally, isolated systems are typically pre-configured with specific vulnerabilities and targets, which may not accurately reflect the diversity of systems and vulnerabilities that exist in the real world. This can limit the students' ability to develop the skills necessary to identify and exploit vulnerabilities in a variety of systems.

Furthermore, real-world scenarios may be affected by factors that are difficult or impossible to simulate in an isolated environment, such as network congestion, power outages, or hardware failures. These factors can impact the behavior of systems and complicate the students' ability to carry out attacks or defend against them. Real-world systems may also have unique security measures and protocols that students may not encounter in an isolated environment. Finally, the behavior of real-world actors, such as other attackers, defenders, or third parties, may be difficult to simulate in a conventional isolated environment.

One daunting aspect of conventional cyberwarfare training is that the networking scenarios available for training are a product of a network administrator's design and creation. As such, these designs are limited to the imagination and biases of such administrators. Of no less importance is the fact that generating such networking scenarios or layouts is very time consuming.

Accordingly, there is an opportunity for platforms and technologies to generate realistic cyberwarfare network environments for enhanced cyberwarfare training realism.

### BRIEF SUMMARY

In one aspect, a computing system for improved migration of a tenant environment includes one or more processors; and a memory having stored thereon instructions that, when executed by the one or more processors, cause the system to: (i) receive, via the one or more processors, one or more content migration project parameters of a user; (ii) receive, via the one or more processors, one or more resource migration project parameters of a user; (iii) receive, via the one or more processors, one or more services parameters of a user; (iv) scan a tenant computing environment to identify, for each of a plurality of schemas, one or more respective signal values; (v) process the content migration project parameters, the resource migration parameters, the services parameters, and the respective signal values to determine costs, profits and pricing information corresponding to the migration of the tenant environment, wherein the processing includes applying at least one multiplier determined by a trained machine learning model; and (vi) cause the costs, profits and pricing information to be displayed on a display device.

In an aspect, a computer-implemented method of generating an emulated networking environment for improved cyberwarfare training realism using machine learning includes (i) receiving, via one or more processors, historical Internet Protocol packet data; (ii) processing the historical Internet Protocol Packet data using a trained machine learning model to generate an emulated networking environment including a plurality of virtual machines, wherein the plurality of virtual machines includes 1) at least one attacker virtual machine, 2) at least one hop virtual machine; and 3) at least one target virtual machine, and wherein each of the respective plurality of virtual machines is connected to at least one other of the plurality of virtual machines via virtual switch; and (iii) causing the plurality of virtual machines to be instantiated.

In another aspect, a computing system for improved cyberwarfare training realism using machine learning includes one or more processors; and one or more memories having stored thereon computer-executable instructions that, when executed by the one or more processors, cause the computing system to: (i) receive historical Internet Protocol packet data; (ii) process the historical Internet Protocol Packet data using a trained machine learning model to generate an emulated networking environment including a plurality of virtual machines, wherein the plurality of virtual machines includes 1) at least one attacker virtual machine, 2) at least one hop virtual machine; and 3) at least one target virtual machine, and wherein each of the respective plurality of virtual machines is connected to at least one other of the plurality of virtual machines via virtual switch; and (iii) cause the plurality of virtual machines to be instantiated.

In yet another aspect, a non-transitory computer-readable medium includes computer-executable instructions that, when executed by the one or more processors, cause a computer to: (i) receive historical Internet Protocol packet data; (ii) process the historical Internet Protocol Packet data using a trained machine learning model to generate an emulated networking environment including a plurality of virtual machines, wherein the plurality of virtual machines includes 1) at least one attacker virtual machine, 2) at least one hop virtual machine; and 3) at least one target virtual machine, and wherein each of the respective plurality of virtual machines is connected to at least one other of the plurality of virtual machines via virtual switch; and (iii) cause the plurality of virtual machines to be instantiated.

### BRIEF DESCRIPTION OF THE FIGURES

The figures described below depict various aspects of the system and methods disclosed therein. It should be understood that each figure depicts one aspect of a particular aspect of the disclosed system and methods, and that each of the figures is intended to accord with a possible aspect thereof. Further, wherever possible, the following description refers to the reference numerals included in the following figures, in which features depicted in multiple figures are designated with consistent reference numerals.

FIG. 1 depicts an exemplary computing environment, according to some aspects.

FIG. 2 depicts an exemplary emulated virtual networking environment 200, according to some aspects.

FIG. 3 depicts an exemplary virtual machine configuration graphical user interface for administering attacker virtual machines, hop virtual machines, and target virtual machines within an emulated virtual networking environment, according to some aspects.

FIG. 4A depicts an example attacker virtual machine shell graphical user interface, according to some aspects.

FIG. 4B depicts an example attacker virtual machine pre-assembled scripts and wordlists graphical user interface, according to some aspects.

FIG. 4C depicts an example attacker virtual machine shell wordlist graphical user interface, according to some aspects.

FIG. 4D depicts an example attacker virtual machine scripts graphical user interface, according to some aspects.

FIG. 4E depicts an example attacker virtual machine packet capture graphical user interface, according to some aspects.

FIG. 4F depicts an example attacker virtual machine packet capture filtering graphical user interface, according to some aspects.

FIG. 4G depicts an example attacker virtual machine shell graphical user interface for simulating an industrial control system human-computer interface based attack, according to some aspects.

FIG. 5A depicts an example attacker virtual machine interface including an attack script, according to some aspects.

FIG. 5B depicts an example attacker virtual machine simulated user industrial control system human-computer graphical user interface, according to some aspects.

FIG. 5C depicts an example brute-force information control system workstation attack script graphical user interface, according to some aspects.

FIG. 5D depicts an example attacker virtual machine brute force attack graphical user interface and packet capture user interface, according to some aspects.

FIG. 5E depicts an example attacker virtual machine brute force attack graphical user interface and packet capture user interface, according to some aspects.

FIG. 5F depicts FIG. 5F depicts an example attacker virtual machine brute force attack shell graphical user interface and packet capture user interface, according to some aspects.

FIG. 5G depicts an example attacker virtual machine brute force attack shell graphical user interface and packet capture user interface, according to some aspects, including remote command execution.

FIG. 5H depicts an example attacker virtual machine attack shell graphical user interface and packet capture user interface, according to some aspects, including output of a directory search attack.

FIG. 5I depicts an example attacker virtual machine attack shell graphical user interface and packet capture user interface, according to some aspects, including output of a directory search attack.

FIG. 6A depicts an example industrial control system human-machine interface chemical plant threat simulation attack graphical user interface including a script, according to some aspects.

FIG. 6B depicts an example of controlling an industrial control system human-machine interface chemical plant graphical login user interface using automated test software, according to some aspects.

FIG. 6C depicts an example packet capture user interface, according to some aspects.

FIG. 6D depicts an example industrial control system human-machine interface chemical plant valve control graphical user interface according to some aspects.

FIG. 6E depicts the example industrial control system human-machine interface chemical plant valve control graphical user interface, representing the state of a valve after a script has written data to the SCADA coil/register.

FIG. 6F depicts the example industrial control system human-machine interface chemical plant valve control graphical user interface, representing the state of the start/stop element after the user has depressed the element.

FIG. 7 depicts an example flow diagram of a computer-implemented method for training and deploying automated cyberwarfare training scenarios, according to some aspects.

FIG. 8A depicts an exemplary computer-implemented method of generating an emulated networking environment for improved cyberwarfare training realism using machine learning, according to some aspects.

FIG. 8B depicts an exemplary computer-implemented method of generating realistic cyberwarfare network data for enhanced cyberwarfare training realism.

### DETAILED DESCRIPTION

### Overview

The present aspects may relate to, inter alia, methods and systems for emulated network environment generation, and more particularly, to methods and systems for generating realistic cyberwarfare network environments for enhanced cyberwarfare training realism.

The present techniques may include a computing environment for generating a virtual network environment that appears realistic to a cyberwarfare student. For example, the virtual network environment may include switches, network hops, virtual switches and/or target hosts that are configured using realistic Internet Protocol (IP) ranges. One or more trained machine learning models may process historical packet data and generate an emulated computing environment based on the processed data. The present techniques may instantiate one or more emulated networking environments based on the emulated computing environment.

In some aspects, the present techniques may include generating simulated network traffic that appears realistic to a cyberwarfare student. For example, one or more machine learning models may process historical packet data and generate simulated IP packets based on the historical packet data. The simulated IP packets may be transmitted via one or more network interface controllers to one or more computing systems (e.g., one or more virtual networking environments), for example, via one or more virtual machines. For example, the present techniques may use the network data packet generation techniques described in U.S. patent application Ser. No. 18/139,097, entitled “Machine Learning Techniques For Automating Cyberwarfare Training Scenarios,” filed on Apr. 25, 2023, and incorporated herein by reference in its entirety.

### Exemplary Computing Environment

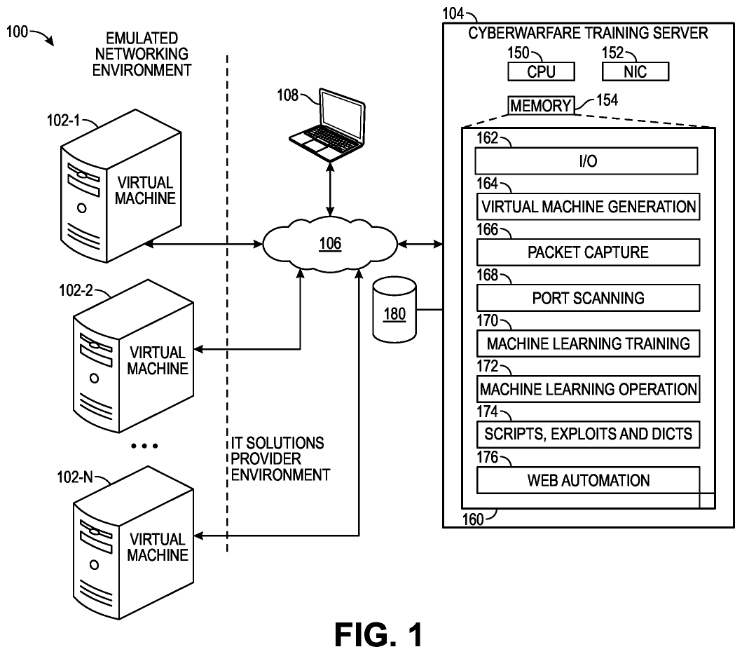

FIG. 1 depicts an exemplary computing environment in which the present techniques may be implemented, according to some aspects. The environment 100 includes an IT solutions provider computing environment and an emulated networking environment. The computing environment 100 may include one or more virtual machines 102, a cyberwarfare training server 104, an electronic network 106, a client computing device 108 and an electronic database 180. Some aspects may include a plurality of cyberwarfare training servers 104.

The virtual machines 102-1, 102-2 through 102-n each be an individual server, a group (e.g., cluster) of multiple servers, or another suitable type of computing device or system (e.g., a collection of computing resources). In particular, the virtual machines 102 may be cloud-based virtual machines coupled via virtual networks, generated by the cyberwarfare training server 104. The one or more virtual machines 102 may be included in a respective remote data center (e.g., a cloud computing environment, a public cloud, a private cloud, hybrid cloud, etc.).

The virtual machines 102 may each include a processor and a network interface controller (NIC). The processor may include any suitable number of processors and/or processor types, such as CPUs and one or more graphics processing units (GPUs). Generally, the processor may be configured to execute software instructions stored in a memory. The memory may include one or more persistent memories (e.g., a hard drive/solid state memory) and stores one or more set of computer executable instructions/modules.

The virtual machines 102 may each includes a respective input device and a respective output device (not depicted). The respective input devices may include any suitable device or devices for receiving input, such as one or more microphone, one or more camera, a hardware keyboard, a hardware mouse, a capacitive touch screen, etc. The respective output devices may include any suitable device for conveying output, such as a hardware speaker, a computer monitor, a touch screen, etc. In some cases, the input device and the output device may be integrated into a single device, such as a touch screen device that accepts user input and displays output. The tenant computing device may be associated with (e.g., owned/operated by) a company that services enterprise customers, and may include software licensed from a third party. For example, the virtual machines 102 may be one of several virtual machines owned/leased by the company.

The NIC of the virtual machines 102 may include any suitable network interface controller(s), such as wired/wireless controllers (e.g., Ethernet controllers), and facilitate bidirectional/multiplexed networking over the network between the virtual machines 102 and other components of the environment 100 (e.g., another virtual machine 102, the cyberwarfare training server 104, an electronic database, etc.).

Each of the virtual machines 102 may include sets of computer-executable instructions for performing various cyberwarfare-related operations, as discussed below. For example, the virtual machines 102 may include instructions that enable the respective virtual machines 102 to perform brute-force attacks of other virtual machines.

The cyberwarfare training server 104 includes a processor 150, a network interface controller (NIC) 152 and a memory 154. The database 180 may be a structured query language (SQL) database (e.g., a MySQL database, an Oracle database, etc.) or another type of database (e.g., a not only SQL (NoSQL) database). The server 104 may include a library of client bindings for accessing the database 180. In some aspects, the database 180 is located remote from the server 104. For example, the database 180 may be implemented using a RESTdb.IO database, an Amazon Relational Database Service (RDS), etc. in some aspects. In some aspects, the server 104 may include a client-server platform technology such as Python, PHP, ASP.NET, Java J2EE, Ruby on Rails, Node.js, a web service or online API, responsive for receiving and responding to electronic requests.

The electronic network 106 may be a single communication network, or may include multiple communication networks of one or more types (e.g., one or more wired and/or wireless local area networks (LANs), and/or one or more wired and/or wireless wide area networks (WANs) such as the Internet). The network 106 may enable bidirectional communication between the virtual machines 102 and the cyberwarfare training server 104, and/or between other multiple virtual machines/devices/instances, for example (e.g., between the server 104 and the client computing device 108).

The client computing device 108 may include one or more processors, one or more non-transitory computer-readable memories, one or more input devices (e.g., computer peripherals) and one or more output devices (e.g., a screen, a printer, etc.). The user/administrator may use the client computing device 108 as a terminal to access/administer any of the other components of the environment 100, such as the server 104, the virtual machines 102, the database 180, etc. The client computing device 108 may be a hardware device or a virtual machine. In some aspects, many (e.g., hundreds or more) of client computing devices 108 may be deployed in the environment 100, for example, to enable access to many students.

The processor 150 may include any suitable number of processors and/or processor types, such as CPUs and one or more graphics processing units (GPUs). Generally, the processor 150 is configured to execute software instructions stored in the memory 154. The memory 154 may include one or more persistent memories (e.g., a hard drive/solid state memory) and stores one or more set of computer executable instructions/modules 160, including an input/output (I/O) module 162, a virtual machine generation module 164, a packet capture module 166, a port scanning module 168, a machine learning training module 170, a machine learning operation module 172, a scripts, exploits and dictionaries module 174; and a web automation module 176.

Each of the modules 160 implements specific functionality related to the present techniques, as will be described further, below. In some aspects, a plurality of the modules 160 may implement a particular technique. The modules 160 may exchange data via suitable techniques, e.g., via inter-process communication (IPC), a Representational State Transfer (REST) API, etc. within a single computing device, such as the server 104. Or, in aspects wherein the server 104 is implemented using multiple servers, a first server may include one module while two other respective servers include other respective modules. In some aspects a plurality of the modules 160 may be implemented in a plurality of computing devices (e.g., a plurality of servers 104). The modules 160 may exchange data among the plurality of computing devices via a network such as the network 106. The modules 160 of FIG. 1 will now be described in greater detail.

Generally, the I/O module 162 includes instructions that enable a user (e.g., an employee of the company) to access and operate the server 104. For example, the employee may be a software developer who trains one or more ML models using the ML training module 170 in preparation for using the one or more trained ML models to generate outputs used in a cyberwarfare training project. Once the one or more ML models are trained, the same user may access the server 104 via the I/O module to cause the cyberwarfare training process to be initiated. The I/O module 162 may include instructions for generating one or more graphical user interfaces (GUIs) that collect and store parameters related to the project, such as migration project name (e.g., Cyberwarfare Games May 2023) or other metadata.

The virtual machine generation module 164 may include a set of computer-executable instructions for generating, deploying and instantiating virtual machine instances. Thus, the virtual machine generation module 164 may include software libraries (i.e., bindings) for spinning up virtual machines under any suitable paradigms, such as Qemu, VMWare, Amazon Web Services, Docker, etc. The virtual machine generation module 164 may include further instructions for generating the one or more virtual machines according to a network configuration or topology that is determined via a trained machine learning model. Specifically, one or more trained machine learning models may be trained to generate emulated networking environments as discussed herein that appear realistic to cyberwarfare students, for mission training purposes. The virtual machine generation module 164 may be directed, or operated, by one or more other modules, such as the machine learning operation module 172. For example, the machine learning operation module 172 may cause the virtual machine generation module 164 to generate a network topology or layout based on output generated by the machine learning operation module 172. In some aspects, the machine learning operation module 172 may cause the virtual machine operation module 164 to generate virtual machines corresponding to the generated network topology (e.g., to instantiate one or more virtual machines in a remote cloud computing infrastructure).

The packet capture module 166 may include a set of computer executable instructions for receiving, retrieving, compressing, and/or storing IP packets. The instructions may include instructions for IPV4 and IPV4 packets in pcap form. For example, the packet capture module 166 may use proprietary code and/or open source libraries (libpcap) to perform some or all of its functions. The packet capture module 166 may store the packets in the database 180, in the memory 154 or in another suitable location. The packet capture module 166 may leverage existing tools for manipulating packet data, such as Ethereal/Wireshark. The packet capture module 166 may include instructions for generating common data formats (e.g., CSV, XML, JSON, etc.) based on the packet data.

In some aspects, the machine learning training module 170 may be configured to generate a network layout or topology based on processing of packet data. Specifically, the machine learning model may include instructions for learning relationships between nodes (e.g., IP addresses) in the packet data, and for grouping the nodes together. The machine learning model may be configured to use an unsupervised learning algorithm (e.g., clustering) for this grouping. In some aspects, the machine learning model may include a generative adversarial network trained to generate network topologies or layouts based on network topologies or layouts discovered from captured packet data.

The port scanning module 168 may include a set of computer-executable instructions for performing port scanning. For example, the port scanning module 168 may include proprietary and/or open source tools for performing some or all scanning functions. Examples of libraries that may be used for port scanning purposes include NMAP, netcat, telnet, cURL, etc. The port scanning module 168 may include sets of computer-executable instructions for automatically interpreting the output of these programs, and for storing outputs, for example in the electronic database 180. Port scanning tools may be written in any suitable computer programming language (e.g., C, Python, Perl, etc.). Several of the examples depicted in the figures herein are written in Python. The port scanning module 168 may provide some or all of the port scanning capabilities to generated virtual machines or other devices (e.g., the virtual machines 102).

In general, a computer program or computer based product, application, or code (e.g., the model(s), such as machine learning models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 150 (e.g., working in connection with the respective operating system in memory 154) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

For example, in some aspects, the ML model training module 170 may include a set of computer-executable instructions implementing machine learning training, configuration, parameterization and/or storage functionality. The ML model training module 170 may initialize, train and/or store one or more ML models, as discussed herein. The trained ML models may be stored in the database 180, which is accessible or otherwise communicatively coupled to the migration assessment server 104. The modules 160 may store machine readable instructions, including one or more application(s), one or more software component(s), and/or one or more APIs, which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein.

The ML training module 170 may train one or more ML models (e.g., an artificial neural network (ANN)). One or more training data sets may be used for model training in the present techniques, as discussed herein. The input data may have a particular shape that may affect the ANN network architecture. The elements of the training data set may comprise tensors scaled to small values (e.g., in the range of (−1.0, 1.0)). In some aspects, a preprocessing layer may be included in training (and operation) which applies principal component analysis (PCA) or another technique to the input data. PCA or another dimensionality reduction technique may be applied during training to reduce dimensionality from a high number to a relatively smaller number. Reducing dimensionality may result in a substantial reduction in computational resources (e.g., memory and CPU cycles) required to train and/or analyze the input data.

In general, training an ANN may include establishing a network architecture, or topology, adding layers including activation functions for each layer (e.g., a “leaky” rectified linear unit (ReLU), softmax, hyperbolic tangent, etc.), loss function, and optimizer. In an aspect, the ANN may use different activation functions at each layer, or as between hidden layers and the output layer. A suitable optimizer may include Adam and Nadam optimizers. In an aspect, a different neural network type may be chosen (e.g., a recurrent neural network, a deep learning neural network, etc.). Training data may be divided into training, validation, and testing data. For example, 20% of the training data set may be held back for later validation and/or testing. In that example, 80% of the training data set may be used for training. In that example, the training data set data may be shuffled before being so divided. Data input to the artificial neural network may be encoded in an N-dimensional tensor, array, matrix, and/or other suitable data structure. In some aspects, training may be performed by successive evaluation (e.g., looping) of the network, using training labeled training samples. As discussed below, training may be performed using a feedback mechanism (e.g., additional training samples) at runtime, to improve the performance of the one or more trained model over time.

The process of training the ANN may cause weights, or parameters, of the ANN to be created. The weights may be initialized to random values. The weights may be adjusted as the network is successively trained, by using one or more gradient descent algorithms, to reduce loss and to cause the values output by the network to converge to expected, or “learned”, values. In an aspect, a regression may be used which has no activation function. Therein, input data may be normalized by mean centering, and a mean squared error loss function may be used, in addition to mean absolute error, to determine the appropriate loss as well as to quantify the accuracy of the outputs. In some aspects, the present techniques may include one or more ML models that perform a regression analysis.

In various aspects, an ML model, as described herein, may be trained using a supervised or unsupervised machine learning program or algorithm. The machine learning program or algorithm may employ a neural network, which may be a convolutional neural network, a deep learning neural network, and/or a combined learning module or program that learns in two or more features or feature datasets (e.g., structured data, unstructured data, etc.) in a particular areas of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques. In some aspects, the artificial intelligence and/or machine learning based algorithms may be based on, or otherwise incorporate aspects of one or more machine learning algorithms included as a library or package executed on server(s) 104. For example, libraries may include the TensorFlow based library, the Pytorch library, and/or the scikit-learn Python library.

Machine learning may involve identifying and recognizing patterns in existing data (such as data risk issues, data quality issues, sensitive data, etc.) in order to facilitate making predictions, classifications, and/or identifications for subsequent data (such as using the models to determine or generate a classification or prediction for, or associated with, the level of effort (e.g., person-hours and cost) necessary to perform a migration). Machine learning model(s), may be created and trained based upon example data (e.g., “training data”) inputs or data (which may be termed “features” and “labels”) in order to make valid and reliable predictions for new inputs, such as testing level or production level data or inputs. In supervised machine learning, a machine learning program operating on a server, computing device, or other processor(s), may be provided with example inputs (e.g., “features”) and their associated, or observed, outputs (e.g., “labels”) in order for the machine learning program or algorithm to determine or discover rules, relationships, patterns, or other machine learning “models” that map such inputs (e.g., “features”) to the outputs (e.g., labels), for example, by determining and/or assigning weights or other metrics to the model across its various feature categories. Such rules, relationships, or other models may then be provided subsequent inputs in order for the model, executing on the server, computing device, or other processor(s), to predict, based on the discovered rules, relationships, or model, an expected output. For example, the ML training module 170 may analyze labeled historical data at an input layer of a model having a networked layer architecture (e.g., an artificial neural network, a convolutional neural network, a deep neural network, etc.) to generate ML models. The training data may be, for example, historical data related to network attacks previously analyzed or stored by the company (e.g., in the form of pcap data files).

The historical data may include labels that indicate, for a given attack, whether the pcap relates to a brute-force attack, a side channel attack, etc. The mapping may be generated by processing pcap files generated during prior attacks. Networks may learn to perform different functions based on the training data, including attack recognition (i.e., whether de novo data (e.g., data never seen previously by the model) corresponds an attack, environment emulation (i.e., generating a realistic computing environment for cyberwarfare training based on processing historical pcap data collected during real-world cyberwarfare attacks), realistic network traffic generation (i.e., generating realistic yet simulated network traffic based on historical real-world attack data), etc.

During training, the labeled data may be propagated through one or more connected deep layers of the ML model to establish weights of one or more nodes, or neurons, of the respective layers. Initially, the weights may be initialized to random values, and one or more suitable activation functions may be chosen for the training process. One or more ML models may be trained to predict outputs based on the training data, and the ML training module 170 may include training a respective output layer of the one or more machine learning models. The output layer may be trained to output a prediction, for example.

Once the model training module 170 has initialized the one or more ML models, which may be ANNs or regression networks, for example, the model training module 170 trains the ML models by inputting labeled data into the models (e.g., historical pcap files labeled as corresponding to either normal data or attack data).

The model training module 170 may divide the labeled data into a respective training data set and testing data set. The model training module 170 may train the ANN using the labeled data. The model training module 170 may compute accuracy/error metrics (e.g., cross entropy) using the test data and test corresponding sets of labels. The model training module 170 may serialize the trained model and store the trained model in a database (e.g., the database 180). The model training module 170 may train and store more than one model. For example, the model training module 170 may train an individual model and generate a realistic cyberwarfare training computing environment in the emulated networking environment 100 for each adversarial country.

In some aspects, the computing modules 160 may include a machine learning operation module 172, comprising a set of computer-executable instructions implementing machine learning loading, configuration, initialization and/or operation functionality. The ML operation module 172 may include instructions for storing trained models (e.g., in the electronic database 180, as a pickled binary, etc.). Once trained, a trained ML model may be operated in inference mode, whereupon when provided with de novo input that the model has not previously been provided, the model may output one or more predictions, classifications, simulated data, simulated networking environments, etc. as described herein.

In some aspects, generative adversarial networks may be used. Specifically, a generative adversarial network having a forger and a discriminator may be trained, so that the network learns to generate realistic yet emulated network environments that will appear real to a cyberwarfare student.

Once the model(s) are trained by the model training module 170, the model operation module 172 may load one or more trained models (e.g., from the database 180). The model operation module 172 applies new data that the trained model has not previously analyzed to the trained model. For example, the model operation module 172 may load a serialized model, deserialize the model, and load the model into memory. The model operation module 172 may load new pcap data that was not used to train the trained model. In other aspects, only historical data may be used to generate additional simulated data (e.g., a simulated computing environment and/or simulated packet data). The model operation module 172 may apply the one or more input tensor(s) to the trained ML model. The model operation module 172 may receive output (e.g., tensors, feature maps, etc.) from the trained ML model.

In operation, one or more users (e.g., one or more programmers, administrators, students, teachers, etc.) may access the computing environment 100 via the client computing device 108. The administrator user may access the server 104 via the client computing device 108 (or directly) for the purpose of training one or more machine learning models. For example, the administrator may upload one or more training scripts or sets of computer-executable instructions to the machine learning training module 170. The administrator may load one or more sets of packet data (e.g., pcap files) from the database 180 or the memory 154. The administrator may execute the uploaded instructions, to train the model using the packet data. In some aspects, the model may generate a proposed network layout based on analyzing the packet data, for example using a trained machine learning model.

The server 104 may generate an emulated networking environment based on the generated network layout/topology. For example, the 102 virtual machines may be generated and instantiated (e.g., in a cloud computing environment). As discussed below, linkages between the virtual machines 102 may be established (e.g., network routes) and the virtual machines 102 may be assigned IP addresses and other networking attributes. For example, the virtual machine generation module 164 may add any number of virtual network interfaces to one or more of the virtual machines 102.

Further, the machine generation module 164 may assign each virtual machines a type, such as an attacker node, a hop node, a target node, etc. The machine generation module 164 may generate other virtual networking devices, such as routers, switches, gateways, databases, Internet-of-Things (IOT) devices, and so on. The machine generation module 164 may generate a layout or topology for administrator review, prior to instantiating any of the devices (e.g., in a cloud environment). In some cases, the process of instantiating the devices may be unattended, such that no human review takes place. In some aspects, the virtual machine generation module 164 may be bounded, such that it is limited in the number of nodes or devices that it can create by time, cost, number, or other relevant criteria.

As discussed herein, the virtual machine generation module 164 may pre-configure the one or more generated nodes (e.g., virtual machines 102) to include data within their respective memories, such as wordlists, scripts, software, etc. for teaching students during offensive and/or defensive cyberwarfare campaigns. The virtual machine generation module 164 may receive/retrieve this data from the scripts, exploits and dictionaries module 174. Once the emulated networking environment has been generated, the cyberwarfare training server enables students and teachers to explore the emulated networking environment to carry out specific attacks or defenses using the provided data, and for packet data corresponding to those activities to be collected via the packet capture module 166.

### Exemplary Emulated Virtual Networking Environment

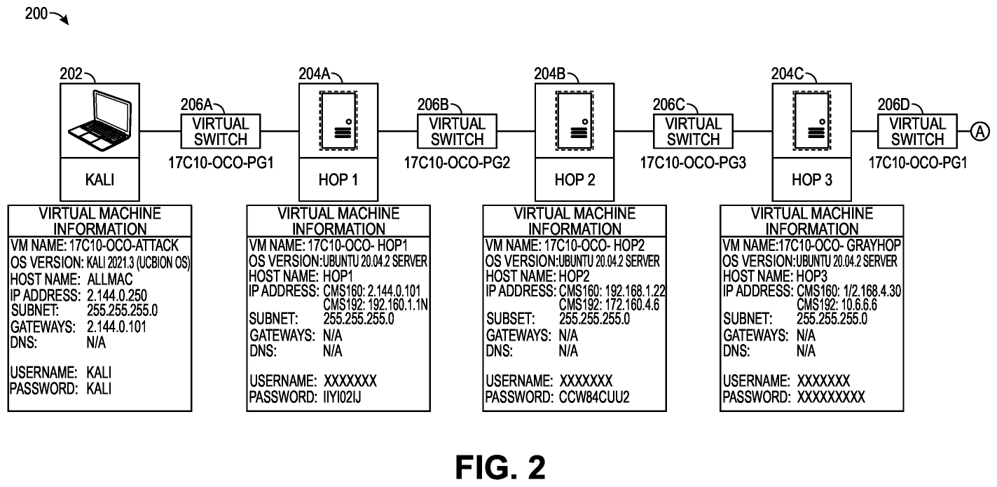

FIG. 2 depicts an exemplary emulated virtual networking environment 200, according to some aspects.

The emulated virtual networking environment 200 may include one or more virtual machines and/or one or more virtual networking devices. For example, FIG. 2 depicts an attacker virtual machine 202 and a plurality of hop virtual devices 204A, 204B and 204C. The attacker virtual machine 202 and the plurality of hop virtual devices 204A, 204B and 204C are communicatively coupled via a plurality of virtual switch devices 206A, 206B, 206C and 206D. The virtual switch 206D communicatively couples the hop device 204C to a plurality of virtual target machines 210A, 210B, 210C and 210D.

The emulated virtual networking environment 200 may be implemented by the virtual machine module 164 of the cyberwarfare training server of FIG. 1, in some aspects. For example, each of the attacker virtual machine 202, the plurality of hop virtual devices 204 and the virtual switches 206 may be instantiated in the memory 154. In some aspects, any of the foregoing may be instantiated in the emulated networking environment. For example, as discussed, one or more virtual machines 102 may be created in the environment 100 of FIG. 1. The virtual machine layout may be generated by one or more trained machine learning models. Herein, the term “instantiate” is understood to mean booting up, powering on or otherwise activating/enabling a virtual machine.

The virtual networking environment 200 may include any number of hop virtual devices, any number of virtual switches, and any number of target devices. It should be that herein, the term “virtual machine,” “virtual device,” and “device” may be used interchangeably.

### Exemplary Computer-Implemented Emulated Virtual Networking Environment Generation

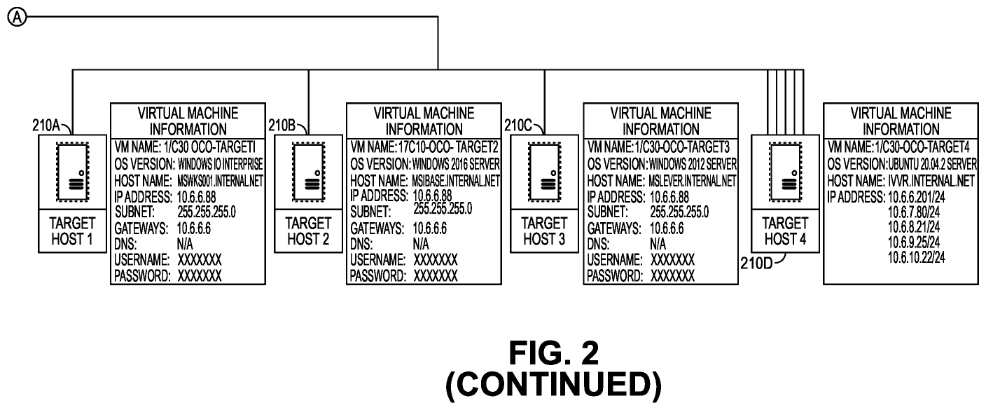

FIG. 3 depicts an exemplary virtual machine configuration graphical user interface 300 for administering attacker virtual machines, hop virtual machines, and target virtual machines within an emulated virtual networking environment, according to some aspects. For example, the virtual machine configuration graphical user interface 300 may be used to configure and instantiate one or more virtual machines (e.g., the attacker virtual machine 202, the virtual devices 204, the virtual switches 206 and/or the virtual target hosts 210 of FIG. 2, in some aspects).

The virtual machine configuration graphical user interface 300 may include a list of virtual machines including a set of attacker virtual machines 302A, a set of hop virtual devices 302B, and a set of target virtual machines 302C. An administrator may use the virtual machine configuration graphical user interface 300 to add, remove, and delete one or more of the aforementioned virtual machines. For example, the virtual machine configuration graphical user interface 300 depicts a selected attacker virtual machine 304 that is running a 64-bit Ubuntu Linux operating system. The virtual machines may run one or more machine images (e.g., VMWare images, QEMU, etc.). The virtual machines may be embodied as distributed virtual machine images executed as instances in a cloud computing environment, such as Microsoft Azure virtual machine instances, Google Cloud Computing Platform virtual machine instances, Amazon Web Services virtual machine instances, etc. Container technologies such as Docker may also be used, in some aspects, to run the virtual machines.

The administrator may use the virtual machine configuration graphical user interface 300 to modify the guest operating system to Windows, or another selection. The administrator may also use the virtual machine configuration graphical user interface 300 to create a virtual network configuration/environment linking one or more virtual machines, such as the virtual networking environment 200 depicted in FIG. 2.

The present techniques may include using machine learning to generate one or more realistic emulated network environments for cyberwarfare training realism. As noted, manually generating network environments for cyberwarfare training is time-consuming and generates results based on administrator bias. For example, the administrator may not be able to effectively generate training scenarios that students find plausible or challenging from an information security perspective. On the other hand, machine learning is particularly suited to generating environments that include patterns not based on or expected by the experiences of human reviewers (e.g., students). For example, in some aspects, the machine learning training module 170 of FIG. 1 may include instructions for generating the virtual machines 102 to include attributes that make the virtual machines appear realistic to the cyberwarfare student. For example, the virtual machines 102 may be assigned IP addresses of certain regions, sovereign territories, or countries that are chosen on the basis of their being likely offensive or defensive targets for the cybersecurity student. Specifically, the machine learning training module may train a machine learning model using real world historical pcap data corresponding to cyberwarfare attacks. The machine learning training module may be trained to generate simulated pcap data based on the training data. Thus, the model may learn which geographic regions and/or traffic patterns are characteristic of cyberwarfare attacks, and be capable of generating simulated data conforming to those patterns.

### Exemplary Emulated Attacker Virtual Machine

As noted, the present techniques may be used to train users to perform offensive and/or defensive computer cyberwarfare. As such, some of the virtual machines are configured as virtual machines for use in offensive campaigns (e.g., the attacker virtual machine 202). The present techniques may include sets of computer-executable instructions for automatically creating, instantiating, and configuring such attacker virtual machines (e.g., via the virtual machine creation module 164 of FIG. 1).

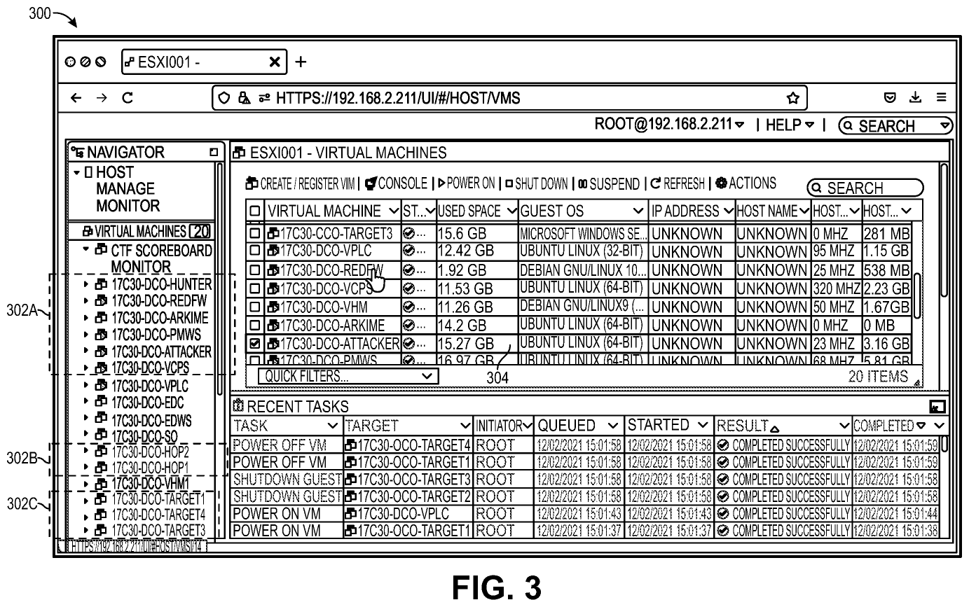

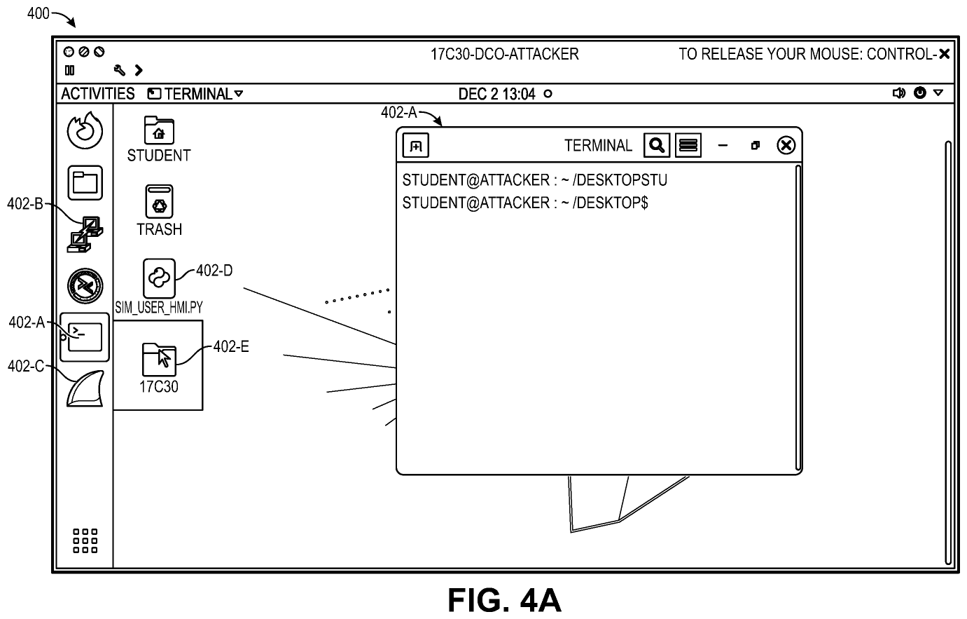

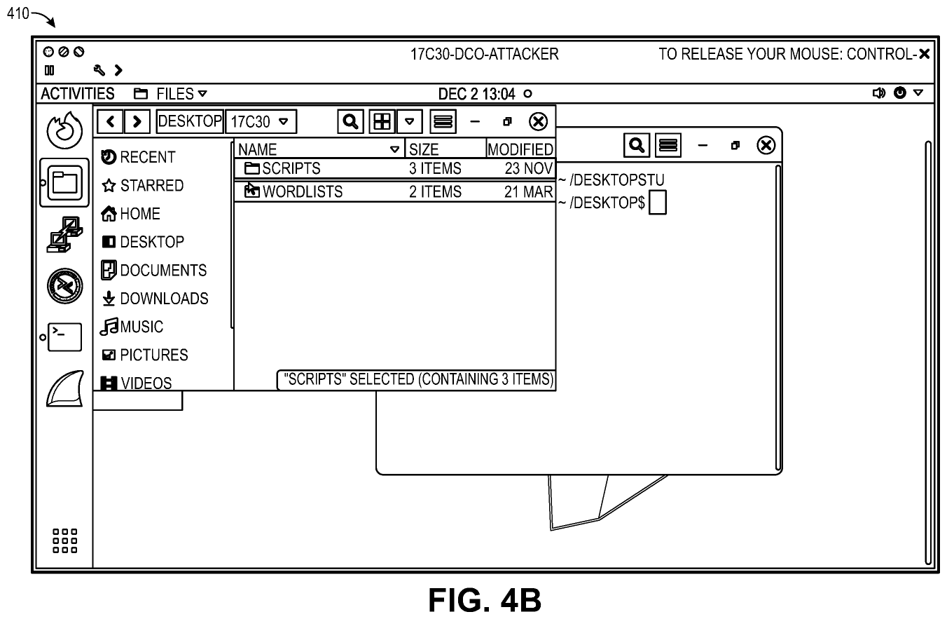

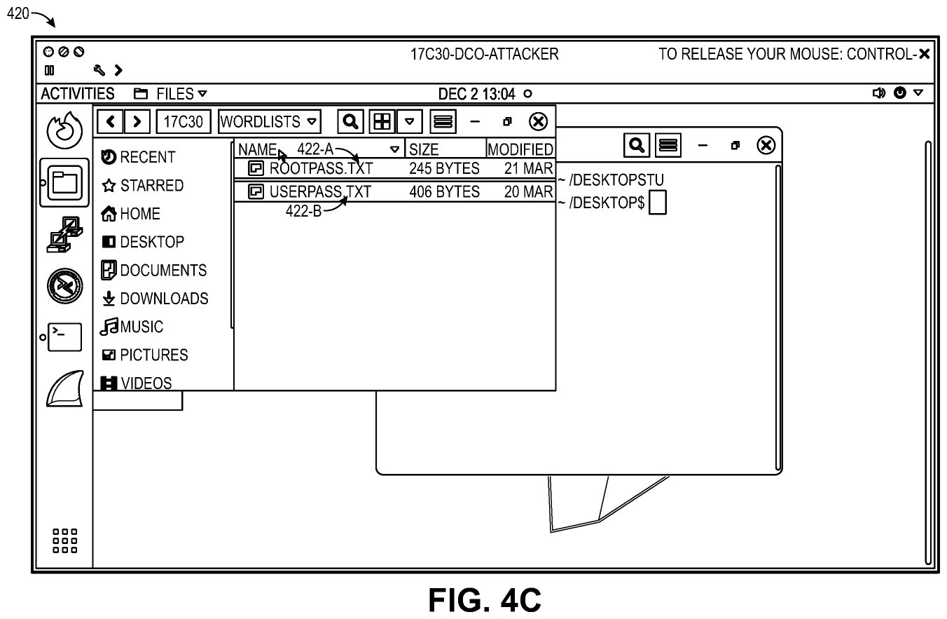

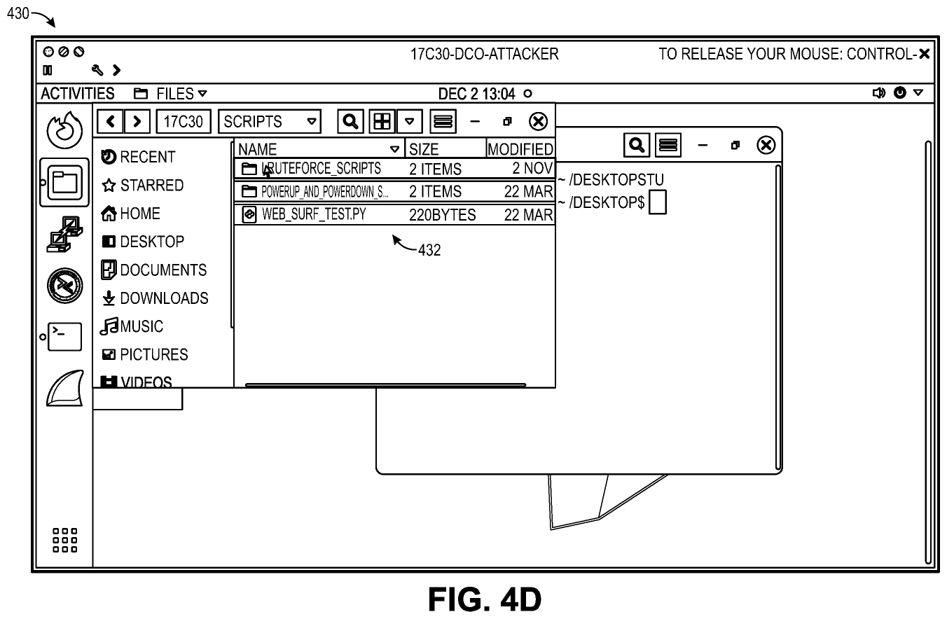

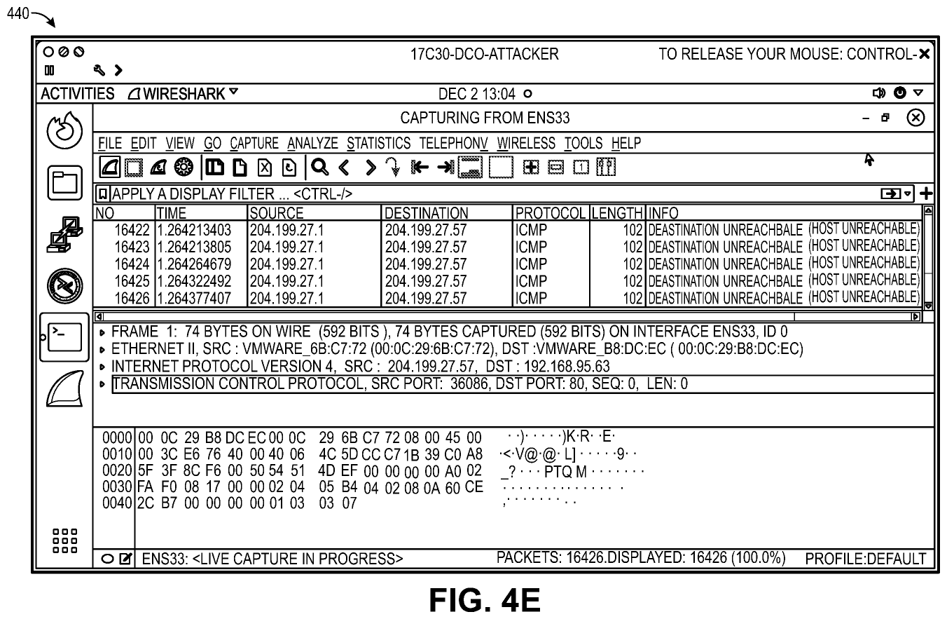

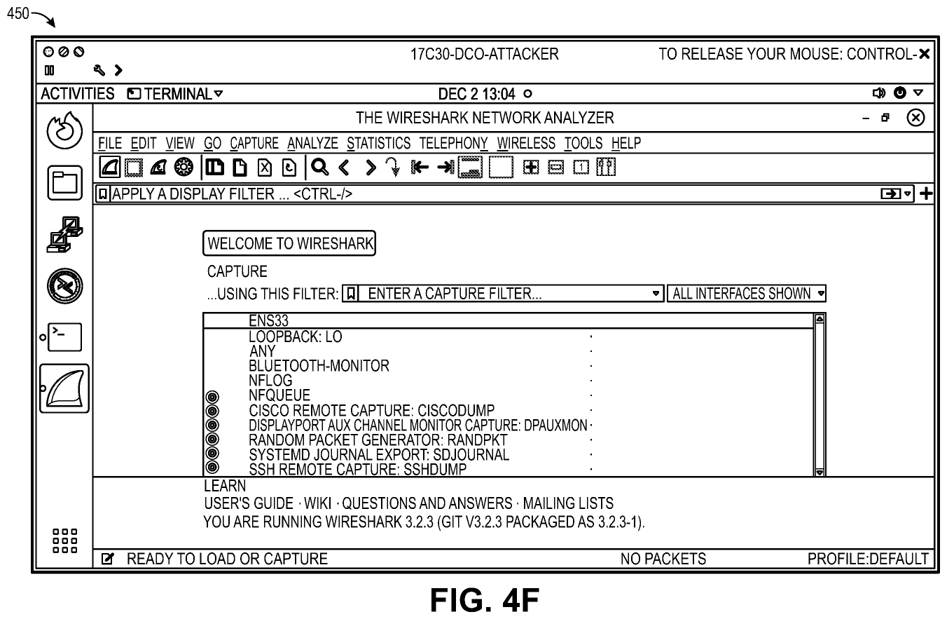

Once the virtual machine is generated and instantiated (e.g., booted up) a user may login to the virtual machine and use the virtual machine to perform various operations, as shown in FIG. 4A.

FIG. 4A depicts an example attacker virtual machine shell graphical user interface 400, according to some aspects. The virtual machine associated with the graphical user interface 400 is named 17C30-DCO-ATTACKER, and corresponds in the depicted example to the attacker virtual machine 304 of FIG. 3. Of course, any suitable name may be used, and there may be many (e.g., 1000 or more) virtual machines, including those configured for offensive purposes, that are automatically generated and configured using the present techniques.

FIG. 4A specifically depicts a UNIX shell providing command line access to a user having the username “student” to use the virtual machine 17C30 (hostname=attacker). The graphical user interface 400 is also pre-configured with facilities that enable the user to perform various networking-related functions, including a terminal 402-A, a secure shell (SSH) client 402-B, a packet capture (pcap) program 402-C, an attack script 402-D and a directory of attack tools 402-E. The directory of attack tools 402-E includes additional wordlists and scripts for performing and parametrizing various cyberwarfare attacks, as depicted in FIG. 4C and FIG. 4D, respectively.

FIG. 4B depicts an example attacker virtual machine pre-assembled scripts and wordlists graphical user interface 410, according to some aspects. The attacker virtual machine shell graphical user interface 410 depicts contents of the wordlists directory (Scripts and Wordlists subdirectories) contained within the directory of attack tools 402-E.

FIG. 4C depicts an example attacker virtual machine shell wordlist graphical user interface 420, according to some aspects. The graphical user interface 420 includes a root user login password wordlist 422-B and a user login password wordlist 422-A. In general, the present techniques (for example, scripts stored in the memory of the virtual machine 17C30) may use the wordlists 422 for executing brute-force attacks, as discussed further below.

FIG. 4D depicts an example attacker virtual machine scripts graphical user interface 420, according to some aspects. The scripts graphical user interface 420 depicts a subdirectory of the directory of attack tools 402-E storing scripts 432 for performing cyberwarfare attack functions. The scripts 432 may include brute-force scripts, remote power up and power down scripts, web surfing scripts, web scraping scripts, etc.

FIG. 4E depicts an example attacker virtual machine packet capture graphical user interface 440, according to some aspects. The attacker virtual machine packet captures graphical user interface 440 depicts a live capture of Internet Protocol Version 4 (IPv4) packets (specifically Transmission Control Protocol (TCP) packets) via a network interface named ens33. The attacker virtual machine packet capture graphical user interface 440 enables the TCP packets generated by the virtual machine 17C30 to be inspected (i.e., viewed by the student/administrator user). In some aspects, the present techniques may capture, generate and/or transmit IPv6 packets and/or UDP packets, in addition to, or alternatively from, IPV4 TCP packets.

FIG. 4F depicts an example attacker virtual machine packet capture filtering graphical user interface 450, according to some aspects. The example attacker virtual machine packet capture filtering graphical user interface 450 enables packet capture to be filtered according to several criteria, including interface, networking protocol, application layer protocol, etc.

The FIGS. 4A-4F demonstrate the product of the virtual machine generation facilities of the present techniques, such as those performed by the virtual machine generation module 164 of FIG. 1. The example attacker virtual machine 17C30 may be pre-configured to include various applications, scripts, packet capture facilities, etc. for performing cyberwarfare attacks. The attacker virtual machine 17C30 may generate packets that are stored (e.g., in a memory of one of the virtual machines 102 of FIG. 1, in the memory of the cyberwarfare training server 104, in the electronic database 180, etc.) by other elements (e.g., the packet capture module 166 of FIG. 1). Once this data is stored, it is available for training one or more machine learning models, as discussed herein.

FIG. 4G depicts an example attacker virtual machine shell graphical user interface 460 for simulating an industrial control system human-computer interface based attack, according to some aspects. The attacker virtual machine shell graphical user interface 460 depicts execution in the shell of the terminal 402-A of the attack script 402-D of FIG. 4A.

### Exemplary Remote Computer-Implemented Attack and Packet Capture

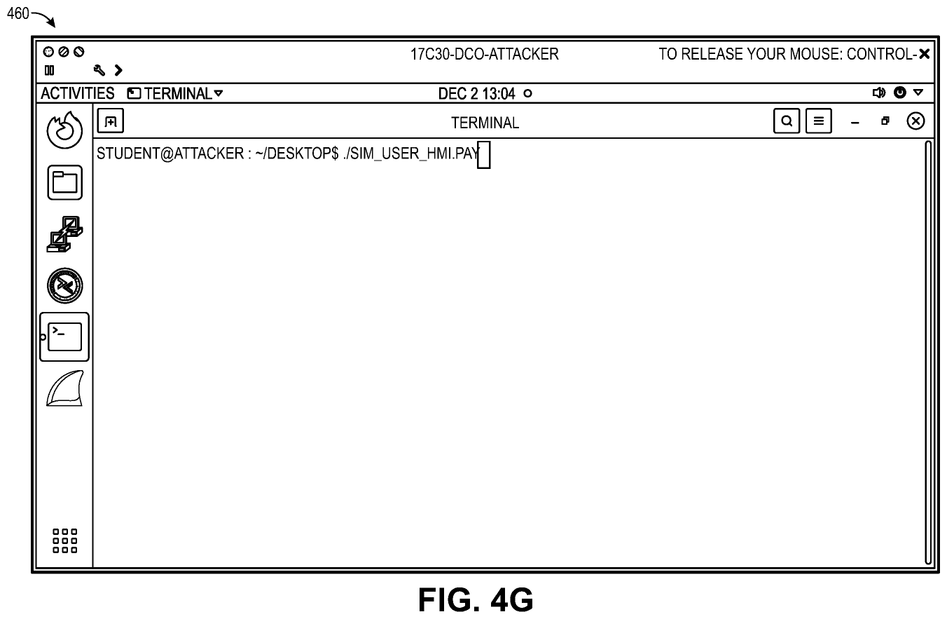

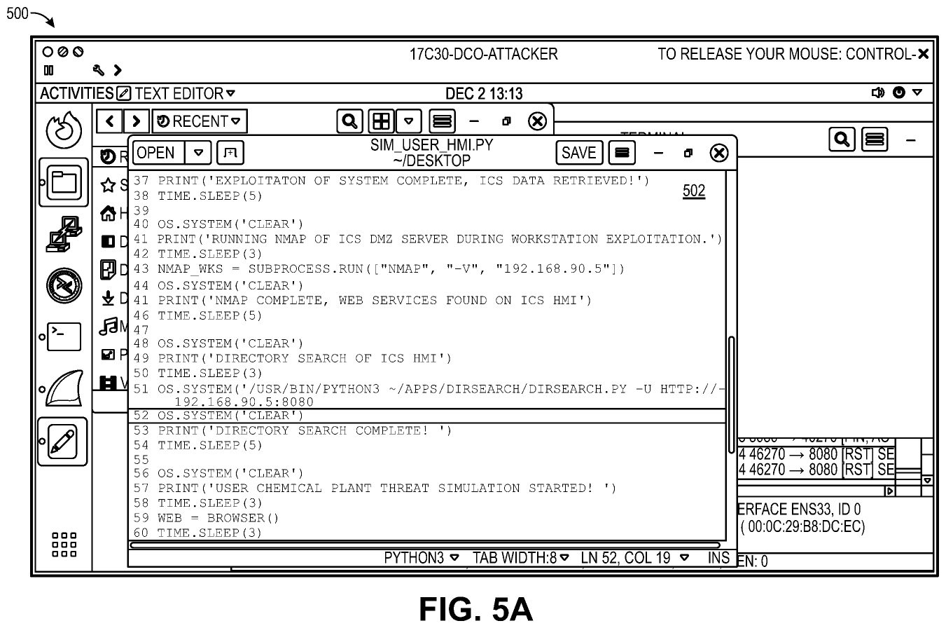

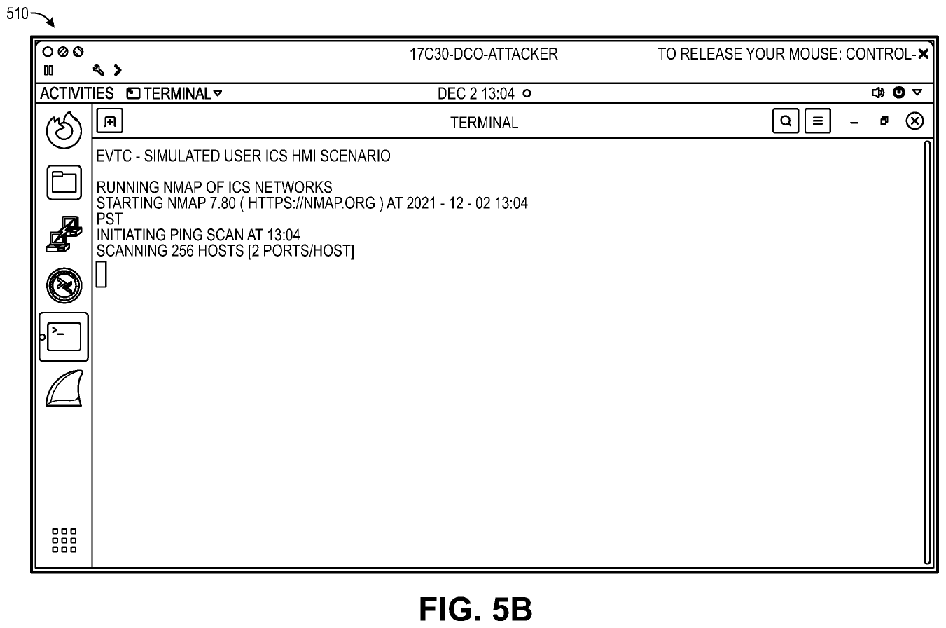

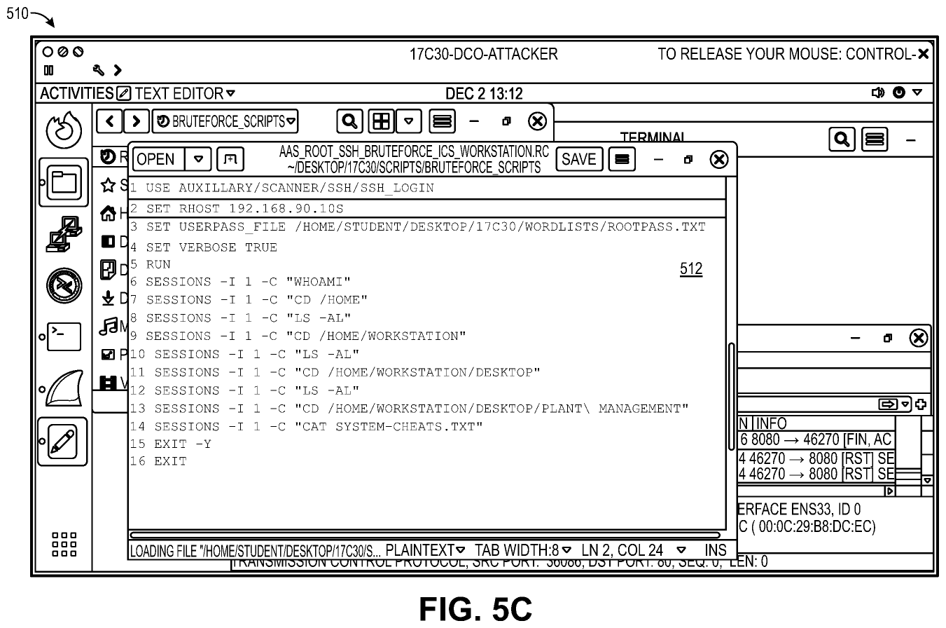

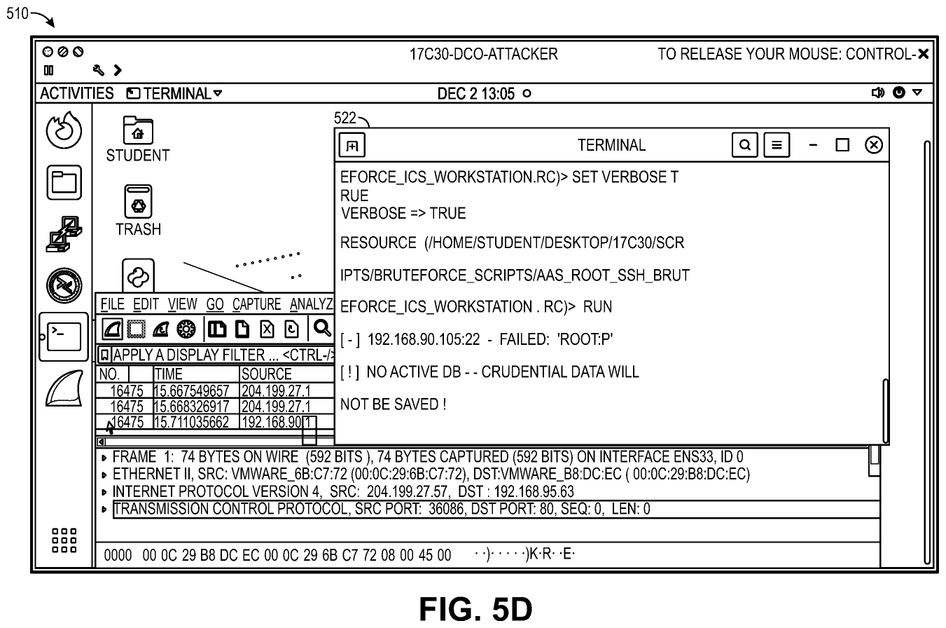

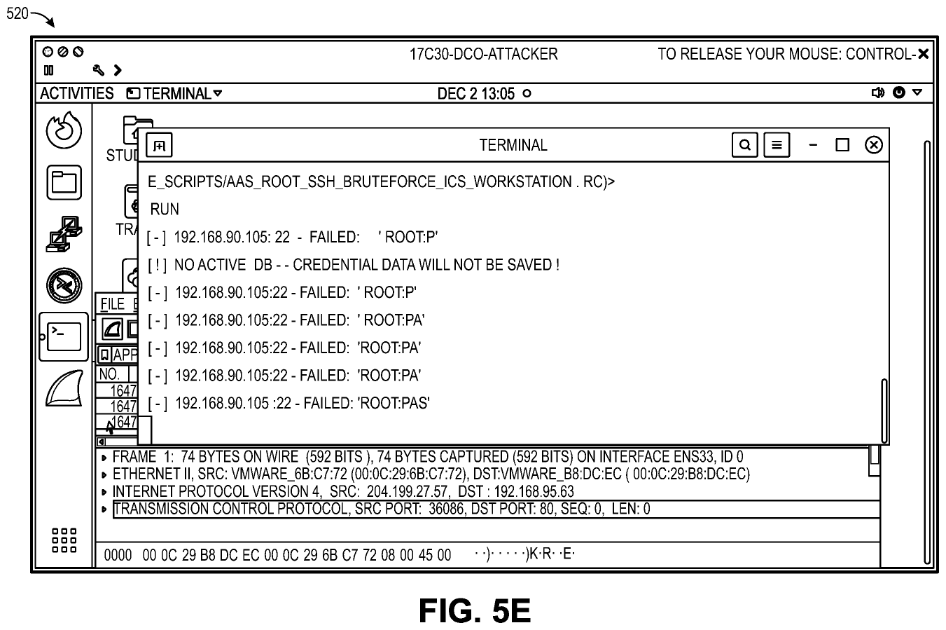

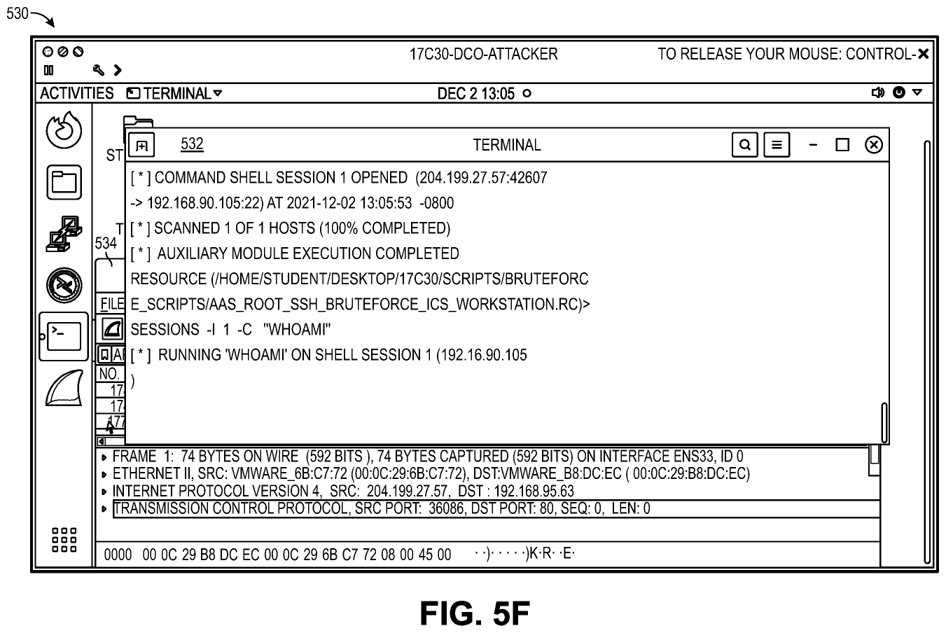

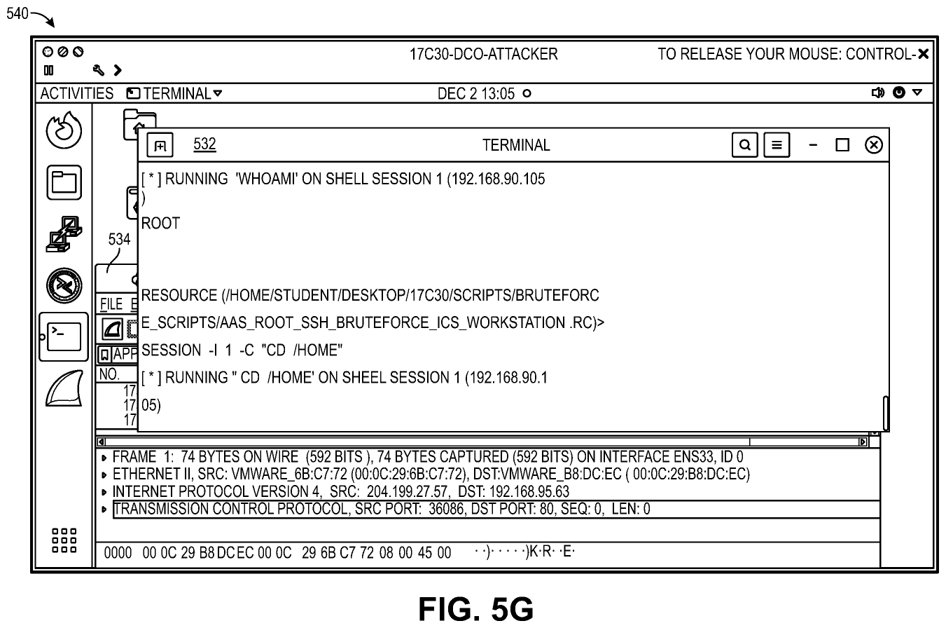

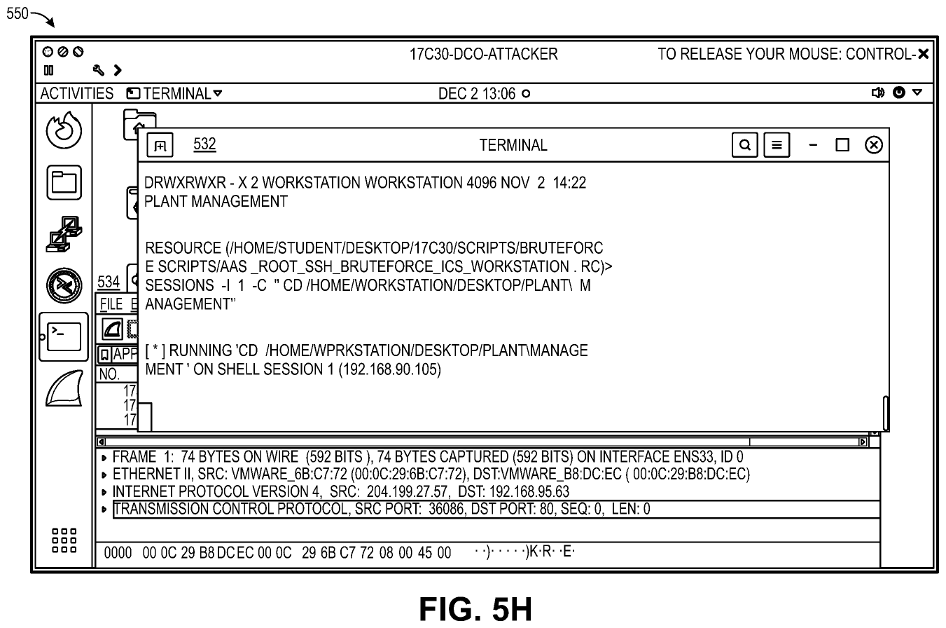

FIG. 5A depicts an example attacker virtual machine interface 500 including an attack script 502, according to some aspects. The attack script 502 includes a set of computer-executable instructions for performing a port scan of a remote host having an IP address (192.168.90.5, line 43), performing a directory search and serving results of the directory search to external hosts via an HTTP server (line 51) and automating operation of a web browser (line 59). Specifically, the attack script 502 may perform its instructions for port scanning via the electronic network 106 of FIG. 1, for example. The port scanning may be performed by the port scanning module 168 of FIG. 1, in some aspects.

For example, the attack script 502 may correspond to a set of computer-executable instructions stored in the port scanning module 168. The cyberwarfare training server 104 may copy a portion of the port scanning module instructions to one of the virtual machines 102 in the form of the attack script 502. The cyberwarfare training server 104 may customize the attack script 502 for certain activities (e.g., which hosts to scan, which services to target, which ports to scan, etc.).

The attack script 502 may scan ports of the virtual machines 102. The attack script 502 may scan ports of Internet hosts (not depicted) accessible via the electronic network 106. The attack script 502 may cause a directory searching script to be run on the remote host and to serve results of the directory searching script to be served via port 8080 on the remote host, so that the virtual machine 17C30 (or another virtual machine) may download the results.

FIG. 5B depicts an example attacker virtual machine simulated user industrial control system human-computer graphical user interface 510, according to some aspects. In particular, the graphical user interface 510 depicts output of the port scanning process shown in FIG. 5A. In some aspects, the port scanning process may discover one or more open ports (e.g., SSH port 22) of one or more hosts, such as the scanned remote host 192.168.90.5. In that case, the virtual machine 17C30, for example, may execute a brute force attack using a brute force attack script, as shown in FIG. 5C.

FIG. 5C depicts an example brute-force information control system workstation attack script graphical user interface 510, according to some aspects. The brute-force information control system workstation attack script graphical user interface 510 includes a brute force script 512 that is executed to cause a root user brute force attack to occur against a remote host identified as having open ports, for example by the port scanning process depicted in FIG. 5A and FIG. 5B. The brute force script 512 may correspond to one of the scripts 432 of FIG. 4D, for example. Specifically, the script 512 includes instructions for performing an SSH login brute-force dictionary-based attack against a remote host (e.g., the host 192.168.90.105). The script 512 includes a series of commands to execute (lines 6-14) if/when the script 512 successfully compromises a remote host via the dictionary-based attack (e.g., when the dictionary-based attack successfully guesses a valid username/password combination). The dictionary may correspond to the wordlist(s) 422 of FIG. 4C, in some aspects.

FIG. 5D depicts an example attacker virtual machine brute force attack graphical user interface and packet capture user interface 520, according to some aspects. The attacker virtual machine brute force attack graphical user interface and packet capture user interface 520 includes a terminal including a shell 522 that may display the output of a brute-force attack script, such as the script 512. The shell 522 depicts the output of executing the script 512 shown in FIG. 5C, including failed username/password pairs (root:p).

FIG. 5D further depicts an example packet capture application 524 that may capture and record (e.g., store) the output of the brute-force attack script executing in the shell 522. The packet capture application 524 may include one or more filters (such as those depicted in FIG. 4F) that restrict the packets captured (e.g., to only those packets relating to TCP traffic for the SSH protocol). The capture of the packets may be initiated and controlled by the script 512 via the shell 522, in some aspects. Thus, FIG. 5D depicts one of the advantages of the present techniques, which is simultaneous automated packet generation and capture for later use (e.g., for model training purposes).

FIG. 5E depicts an example attacker virtual machine brute force attack graphical user interface and packet capture user interface 520, according to some aspects. FIG. 5E depicts further brute force scanning, wherein the passwords are selected from a word list (e.g., the wordlist 422-A) and tried sequentially. While FIGS. 5B-5E depict a brute for SSH attack, other attack strategies, attack targets and attack vectors may be employed. In some aspects, the present techniques may include attacks based on an exploit framework, such as the Metasploit framework, for cataloguing and crafting cyberwarfare attacks.

FIG. 5F depicts FIG. 5F depicts an example attacker virtual machine brute force attack shell graphical user interface and packet capture user interface 530, according to some aspects. Specifically, FIG. 5F depicts a shell 532 in which commands are being executed against a remote host (i.e., 192.168.90.105) over port 22 (i.e., SSH) because the brute-force scanning was successful-in other words, one of the dictionary-based attacks worked. Thus, the series of commands in script 512 discussed above are being executed in the compromised remote host. The result of this execution is continued in FIG. 5G, in the shell 532 and packet capture application 534, which record the successful login and remote command control of the compromised host. Specifically, FIG. 5G depicts an example attacker virtual machine brute force attack shell graphical user interface and packet capture user interface, according to some aspects, including remote command execution. Thus, the present techniques may capture packets corresponding to successful authentication/login via SSH and other protocols.

As noted, once the attacker virtual machine 17C30 successfully compromises one or more remote hosts, the virtual machine 17C30 may execute additional instructions/commands (e.g., directory search traversals) to identify additional services or hosts for exploitation. For example, once the shell 532 has completed the successful brute-force attack discussed above, the shell 532 may execute the directory script depicted in FIG. 5A (line 51), publishing results of that search at the port 8080 on the remote host, from which the virtual machine 17C30 (or another host) may retrieve the results of the directory search. Execution of further attacks after an initial successful breach (e.g., via a password-based brute-force attack) may be referred to as a side-channel attack. The script depicted in FIG. 5A may perform other/additional side-channel attacks (e.g., de-militarized zone scanning), in some aspects.

FIG. 5H depicts an example attacker virtual machine attack shell graphical user interface and packet capture user interface, according to some aspects, including output of a directory search attack. FIG. 5H depicts output in the shell 532 corresponding to the directory search script. In particular, the directory search locates a Plant Management subdirectory at the remote host.

FIG. 5I depicts an example attacker virtual machine attack shell graphical user interface and packet capture user interface, according to some aspects, including output of a directory search attack. In FIG. 5I, output of the directory search is shown in the shell 532 output as being published to port 8080 at the remote compromised host. As above, the packet capture application 534 may capture the transmission of the packets corresponding to the SSH session wherein the output of the directory search script is displayed in the shell 532. Thus, the present techniques enable capture of packets corresponding to a successful compromise and side-channel attack (e.g., via a directory traversal), and publication of that attack. These packets are yet another source of training data that the machine learning training module 170 may use for training machine learning models. For example, the machine learning training module 170 may process these packets to train a supervised learning model to predict whether a given set of packets includes a side-channel attack.

### Exemplary Remote Power Down Computer-Implemented Attack and Packet Capture

In some aspects, the aforementioned dictionary-based attack strategies may be mere preliminary footholds in what may be much more comprehensive and, indeed, damaging cyberwarfare campaigns. For example, in some aspects, the present techniques may be used to automate and record more sophisticated attacks that affect large systems such as industrial control systems (ICS) such as distributed control systems (DCS), supervisory control and data acquisition (SCADA) systems, etc. These attacks may be devastating, considering that DCS, SCADA and similar systems are frequently mission-critical systems that require high availability. Any interruption to these systems, which power critical infrastructure such as electric grids, natural gas facilities, mining operations, etc., may cause catastrophic failures that may include loss of property/life. In some aspects, the present techniques may advantageously assist cyberwar personnel in learning to prevent or mitigate such attacks through modeling simulated attacks.

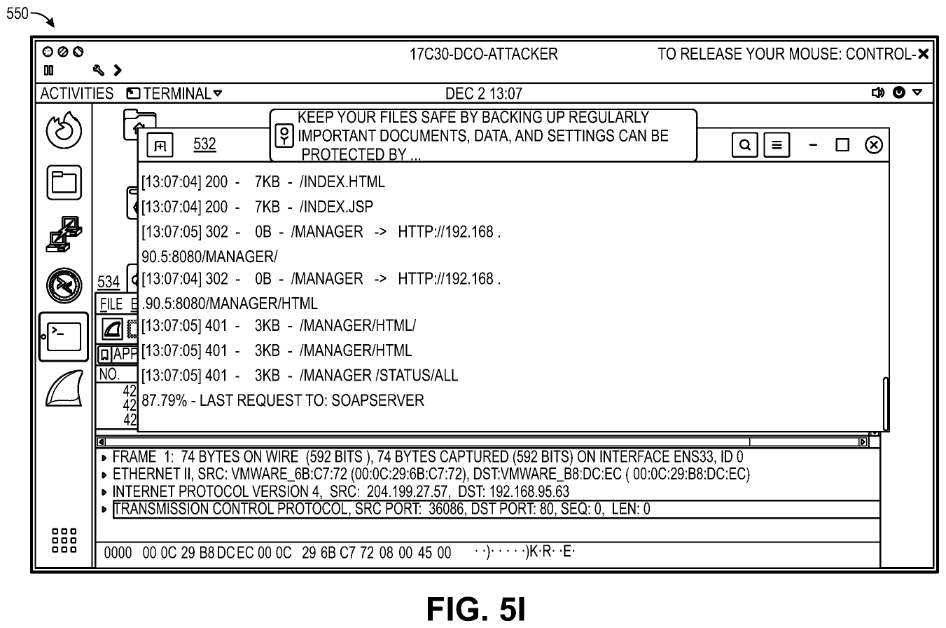

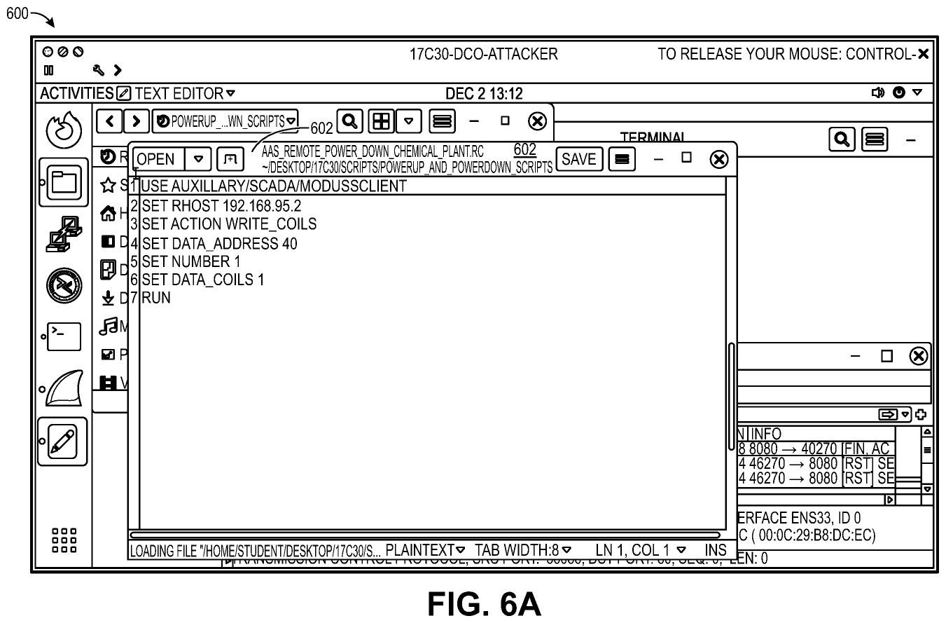

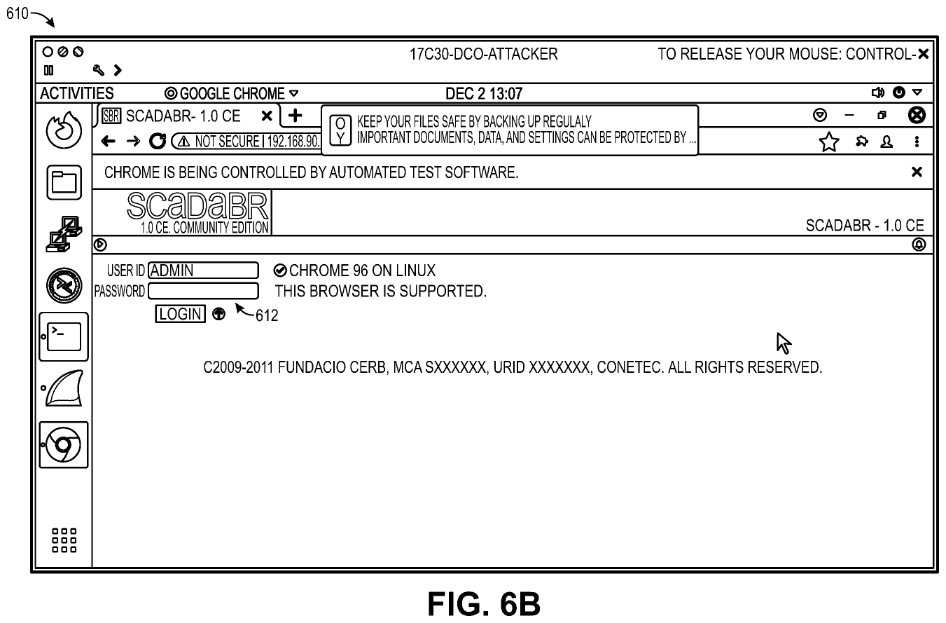

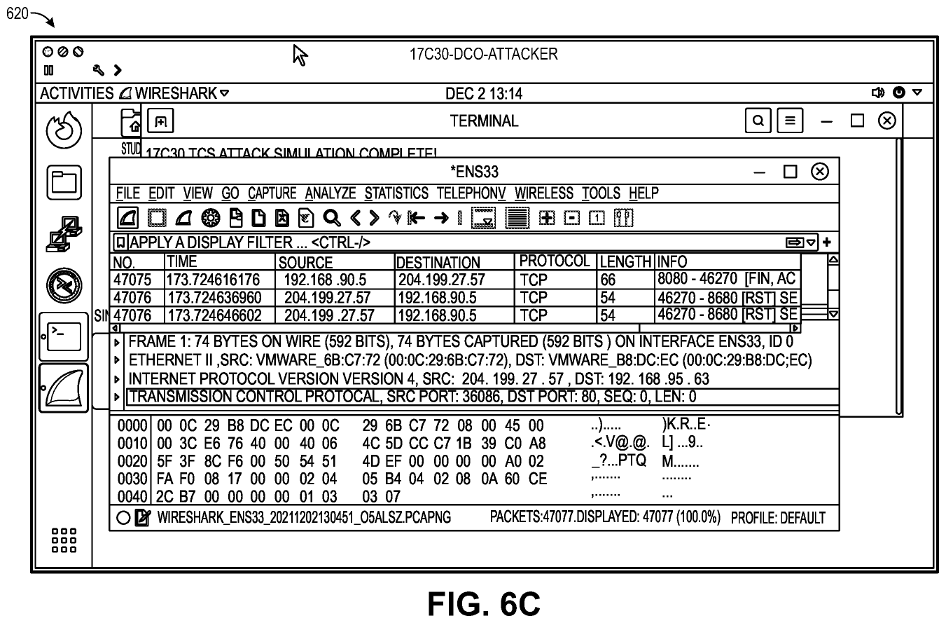

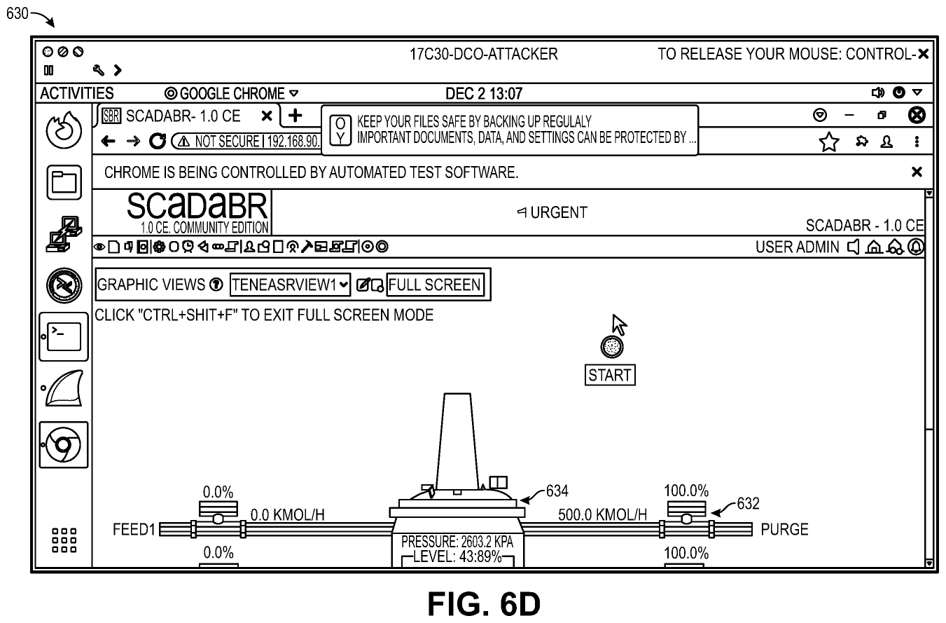

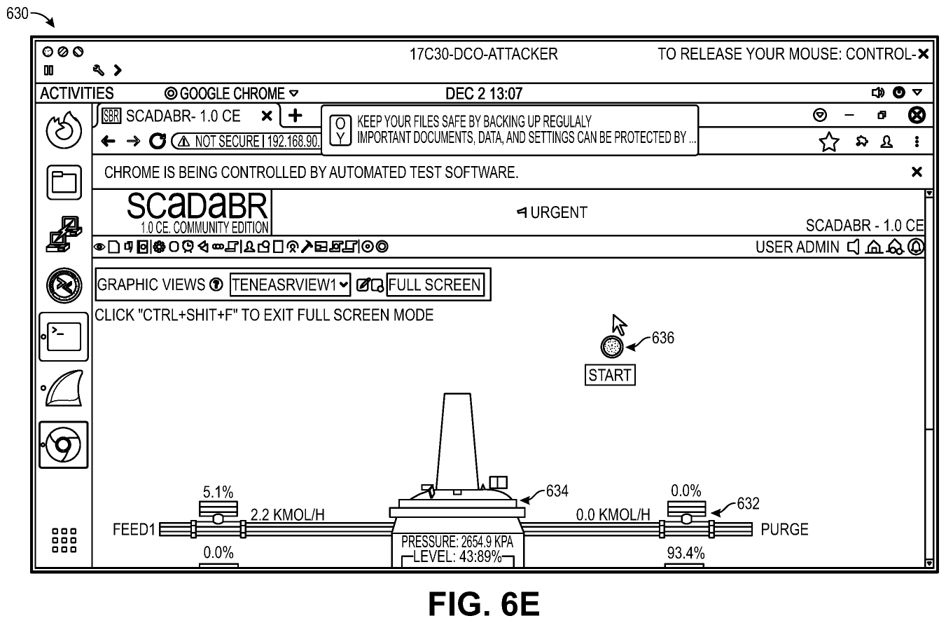

FIG. 6A depicts an example industrial control system human-machine interface chemical plant threat simulation attack graphical user interface 600 including a script 602, according to some aspects. The script 602 may include a set of computer-executable instructions for modifying parameters of a SCADA architecture system. As shown in FIG. 6A, the script 602 includes parameters for reading and writing data to coils and registers of the SCADA system. In the depicted example, the script 602 includes instructions for writing data (1) to an address (40) of a data coil (1) at a particular remote host (192.168.95.2). For example, the script may be installed in the virtual machine 17C30 by the virtual machine generation module 164 of FIG. 1. The virtual machine generation module 164 may access one or more SCADA-specific scripts (e.g., the script 602) in the scripts, exploits and dictionaries module 174. The virtual machine generation module 164 may install additional capabilities when generating the virtual machine, such as web automation capabilities.

FIG. 6B depicts an example of controlling an industrial control system human-machine interface chemical plant graphical login user interface 610 using automated test software, according to some aspects. Specifically, the web automation module 176 may install a set of computer-executable instructions in the virtual machine 17C30 that, when executed, cause the virtual machine 17C30 to execute attacks against a login form 612 of the login interface 610. The instructions may perform one or more attacks, including dictionary-based attacks, cross-site scripting attacks, etc. to attempt to gain access via the login form. The instructions may include instructions for applying dictionary attacks that are based on previously-successful dictionary attacks. For example, the instructions may use credentials used to gain access to one or more remote host, for example, as depicted in FIG. 5F. Furthermore, existing credentials (e.g., root credentials) may be used to change the passwords of users based on a dictionary of usernames. For example, administrator credentials could be used to change the password of the admin user, and those new credentials could then be used to login via the login form 612.

As above, packets may be captured throughout the execution of the automated test software instructions in FIG. 6B. FIG. 6C depicts an example packet capture user interface 620, according to some aspects. The packets captured during the compromise of the user interface 610 may be stored and used by other processes as historical data (e.g., for training one or more machine learning models). Thus, the present techniques may advantageously include training models to recognize sophisticated attacks on critical infrastructure systems based on pcap data.

The effects of compromising certain systems may be devastating, as discussed above. FIG. 6D depicts an example industrial control system human-machine interface chemical plant valve control graphical user interface 630 according to some aspects. The industrial control system human-machine interface chemical plant valve control graphical user interface 630 depicts a purge valve 632 operating at 100% (flowing at 500 kMol/h) and a tank 634 having a pressure of 2603 kPa. FIG. 6E depicts the example industrial control system human-machine interface chemical plant valve control graphical user interface 630, representing the state of the valve 632 after the script 602 has written its data to the SCADA coil/register. As shown, the flow of the valve 632 has been reduced to 0.0 kMol/h. In FIG. 6E, The tank 634 pressure has increased to 2654.9 kPa, and the flow of the valve 632 has reduced to 0.0 kMol/h. The flow of other valves has been affected as well. It should be apparent to those of ordinary skill in the art that even minor perturbations in the pressures and flow rates of complex industrial systems such as those depicted in FIG. 6D and 6E may cause catastrophic consequences, especially if not detected over time.

Further, it should be appreciated that writing values to SCADA coil/registers is only one way to affect plant operating parameters. In some aspects, the present techniques enable the user to modify such values directly using a graphical user interface. For example, FIG. 6E depicts an additional graphical user interface start/stop element 636. The user may, by depressing this control, stop an in-progress process. FIG. 6F depicts the example industrial control system human-machine interface chemical plant valve control graphical user interface 630, representing the state of the start/stop element 636 after the user has depressed the element 636. The present techniques may capture pcap data corresponding to changes made via command line parameters, as well as user interface controls. Thus, the present techniques may be used, advantageously, to train models to detect intrusions, whether those intrusions involve command line/and or GUI-based network traffic.

### Exemplary Computer-Implemented Methods

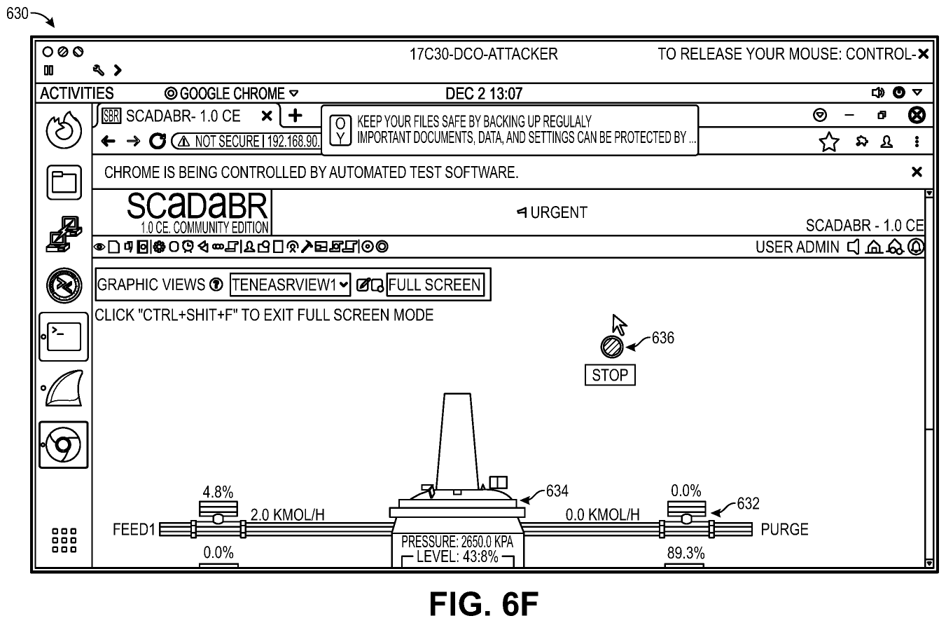

FIG. 7 depicts an example flow diagram of a computer-implemented method 700 for training and deploying automated cyberwarfare training scenarios, according to some aspects. The computer-implemented method 700 may include training one or more machine learning models (block 702).

At block 702, the training may include creating one or more data models. For example, the machine learning training module 170 may include creating one or more machine learning models. For example, the method 700 may use an open source framework to instantiate an untrained model, and associating the untrained model with a training data set (e.g., pcap data) stored in one or more electronic database (e.g., the electronic database 180 of FIG. 1). The method 700 may include training the data model using one or more machine learning models (e.g., one or more artificial neural networks, deep learning models, etc. as discussed above). In some aspects, training the data model may include loading data from one or more pre-assembled data sets. The pre-assembled data sets may include pcap data collected as described herein, and/or data from one or more public data sets. The method 700 may include evaluating the data model, and in some aspects, retraining the data model. For example, the method 700 may include evaluating the data model during network execution and monitoring (e.g., by feeding live pcap data to the data model). Specifically, the data model may be executed and monitored while an automated process performs a cyberwarfare exercise. The model may be automatically evaluated and trained further depending upon how well the model detects activities of the cyberwarfare exercise. In some aspects, the automatic evaluation may be performed by a scoring engine that generates score data output representing the capabilities of the trained model. The method 700 may include exporting the trained data model.

The computer-implemented method 700 may include deploying and operating one or more machine learning models (block 704). The model trained at block 702 may be received/retrieved via a data bridge. Specifically, again with respect to FIG. 1, the machine learning operation module 172 may receive/retrieve one or more models trained by the machine learning training module 170, and operate those models by loading them into the memory and processing data (e.g., live/buffered pcap data) using the loaded models. In some aspects, the one or more loaded models may be parameterized using stored weights previously determined and stored during training. The machine learning operation module 172 may transmit, store and/or display the results of the machine learning analysis.

Turning again to FIG. 7, at block 704, the computer-implemented method 700 may include importing and reading the data model via a network model reader (e.g., a set of computer-executable instruction) that is part of the machine learning operation module 172. The method may include executing the one or more models (e.g., the data model of FIG. 7) using a network data execution engine (e.g., a set of computer-executable instructions) that is part of the machine learning operation module 172. The method 700 may include generating simulated network traffic. Specifically, the machine learning operation module 174 may include transmitting outputs of the one or more machine learning models (e.g., simulated network packets) via the NIC 152. In some aspects, the method 700 may include loading new data (e.g., live/buffered pcap data) into the one or more trained models. In some aspects, the new data (e.g., the live/buffered pcap data) may be loaded into the trained model(s) continuously.

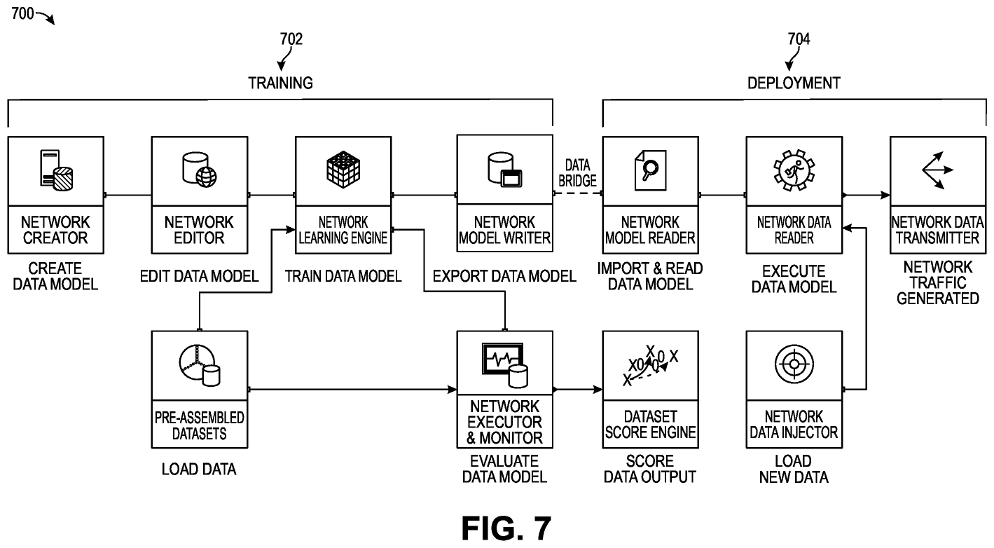

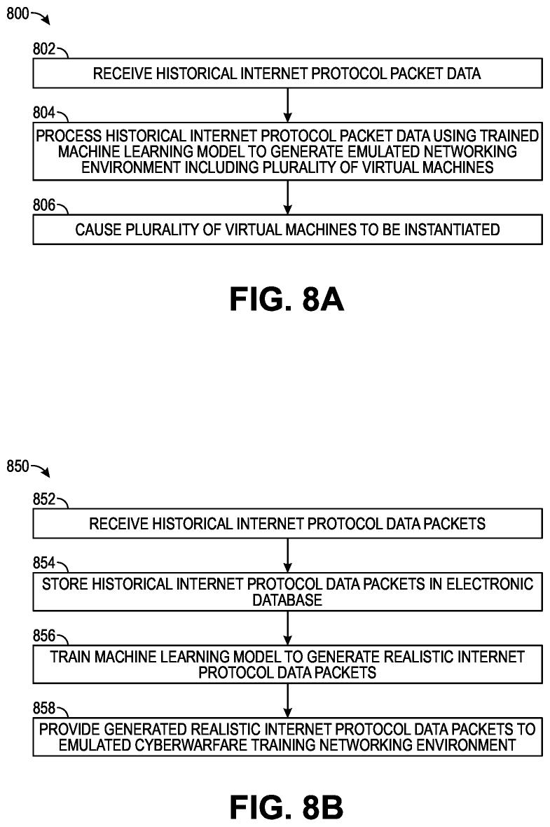

FIG. 8A depicts an exemplary computer-implemented method 800 of generating an emulated networking environment for improved cyberwarfare training realism using machine learning. For example, the method 800 may be performed by components in the environment 100 of FIG. 1, including the server 104 and the virtual machines 102.

The method 800 may include receiving, via one or more processors, historical Internet Protocol packet data (block 802). The historical Internet Protocol packet data may be generated by the virtual machines 102, in some aspects. In some aspects, the historical Internet Protocol data packets may be generated by remote hosts during real world cyberwarfare training. Thus, the stored historical Internet Protocol data packets may correspond to real-world and/or simulated network traffic. The method 800 may include processing the data packets using the packet capture module 166 of the server 104 as described herein, and/or storing the data packets (e.g., in the database 180 or the memory 154 of FIG. 1).

The method 800 may include processing the historical Internet Protocol Packet data using a trained machine learning model to generate an emulated networking environment including a plurality of virtual machines, wherein the plurality of virtual machines includes 1) at least one attacker virtual machine, 2) at least one hop virtual machine; and 3) at least one target virtual machine, and wherein each of the respective plurality of virtual machines is connected to at least one other of the plurality of virtual machines via virtual switch (block 804). The machine learning model may be trained using example data packets, wherein the machine learning model discovers network structure by processing data packets to generate a layout or topology corresponding to a de novo electronic network. For example, the machine learning model may be trained to output an undirected graph corresponding to a network layout. In some aspects, the machine learning model may be configured to add randomness to the generated network layout. For example, the machine learning model may be configured to select a virtual machine having a randomized type, to add a virtual machine on a randomized basis, or to add randomized network connections between virtual machines/hosts.

The method 800 may include causing the plurality of virtual machines to be instantiated (block 806). The method 800 may instantiate the virtual machines using a library of software routines for accessing various cloud computing platforms, local/private clouds, virtual instances stored in a data center, etc.

The method 800 may further include generating the plurality of virtual machines, wherein the generating includes installing one or more scripts in at least one of the plurality of virtual machines. As discussed, one of the advantages of the present techniques is facilitating deployment of realistic computing devices in cyberwarfare training systems. Whereas conventional systems require an administrator to manually configure the computing environment/network environment, the present techniques automate the entire process, improving the speed and efficiency of cyberwarfare training systems, and making the training more realistic. Whereas conventional networks would include mere duplicates of hosts, or only slightly different networked machines, and require laborious work on the part of network administrators, on the other hand, the present techniques may generate highly differentiated virtual machines that are connected and configured in different ways, in mere seconds. This represents a significant improvement to cyberwarfare training computing systems, resulting in products that are more realistic and therefore useful for training students, much more efficiently.

The method 800 may further include generating the plurality of virtual machines, wherein the generating includes storing one or more wordlists in at least one of the plurality of virtual machines. The wordlists may include a privileged user dictionary and a non-privileged user dictionary. The present techniques may include adding wordlists, dictionaries and other databases of information that may be useful for parametrizing automated attack techniques.

The method 800 may further include generating the plurality of virtual machines, wherein the generating includes storing at least one of 1) a brute-force attack script, 2) a side-channel attack script, 3) a power-up attack script, 4) a power-down attack script, or 5) a web automation attack script in at least one of the virtual machines. In some aspects, other attack techniques may be included, such as those catalogued in exploit frameworks (e.g., Metasploit). In some aspects, the method 800 may include generating the plurality of virtual machines, wherein the generating includes configuring the virtual machines to include certain vulnerabilities (e.g., open ports, unsecured services, vulnerable services, etc.). In this way, students may be selectively provided with hosts that may be easier to compromise during the cyberwarfare training process. The method 800 may include storing a copy of the configuration of the generated training network (e.g., a copy of the layout/topology) along with the information stored on each virtual host for review by the administrator.

The method 800 may further include receiving, from the plurality of virtual machines, one or more Internet Protocol data packets; and storing, via one or more processors, the packets in an electronic database. After the virtual machines (and/or other networking components) are instantiated, and begin to generate networking traffic (e.g., data packets), the method 800 may capture the data packets (e.g., using the data capture module of FIG. 1.). Thus, the generated virtual machines may be the source of yet more training data that may be used to further train models. For example, if the virtual machine is a hop virtual machine, such as the hop virtual machine 204B of FIG. 2, the method 800 may include collecting that data and labeling it as hop data, while the students are actively sending data packets across the hop virtual machine. The method 800 may listen, for example, on a network interface connecting the hop virtual machine 204B with the switch 206C. Of course, the method 800 may listen to packet data on multiple interfaces simultaneously. By listening to the hop virtual machine 204B, the method 800 may generate useful labeled data that can be used for subsequent targeted model training. For example, a model may be trained to generate realistic data packets corresponding to a hop node during an HTTPS replay attack.

The method 800 may further include generating the plurality of virtual machines, wherein the generating includes storing instructions for modifying an industrial control system in at least one of the plurality of virtual machines. As discussed, one of the primary targets for modern cyberwarfare is industrial systems, because disrupting these systems can be highly damaging in the physical world, and because these systems typically constitute critical infrastructure for both civilian and military applications. Of course, the present techniques may be used to generate realistic cyberwarfare training scenarios for other critical infrastructure types, such as financial, medical, aeronautical, nuclear/radiological, chemical, biological, dams, communications, commercial facilities, manufacturing, defense industrial, energy, emergency services, government facilities, food and agriculture, information technology, transportation, waste disposal, water, wastewater, etc.

FIG. 8B depicts an exemplary computer-implemented method 850 of generating realistic cyberwarfare network data for enhanced cyberwarfare training realism. For example, the method 800 may be performed by components in the environment 100 of FIG. 1, including the server 104 and the virtual machines 102.

The method 850 may include receiving, via a packet capture module, historical Internet Protocol data packets (block 852). In some aspects, receiving the historical Internet Protocol data packets includes labeling the historical Internet Protocol data packets as corresponding to at least one of (i) a cyberwarfare attack scenario, or (ii) a cyberwarfare defense scenario. In some aspects, training the machine learning model to generate the realistic Internet Protocol data packets by processing the historical Internet Protocol data packets includes selecting the historical Internet Protocol data based on the labeling. Specifically, the method 850 may include storing the data packets in the database 180, for example, wherein the data packets are associated with one or more label columns. Subsequently, the data packets may be selected or queried based on the label column(s), so that effectively, a model could be trained using any number of specific labels. For example, the packet data could be selected based on a timestamp, a node type (e.g., hop, switch, attack, target, etc.), a protocol type (e.g., TCP, UDP, etc.), an IP range, a country/region/geolocation range, an application protocol (e.g., HTTP, SSH, FTP, etc.), a destination port range, a source port range, a student identifier, an instructor identifier, etc. This enables very granular training data to be retrieved and used for targeted model training.

The method 850 may include storing, via one or more processors, the historical Internet Protocol data packets in an electronic database (block 854). In some aspects, storing the historical Internet Protocol data packets in the electronic database includes storing the historical Internet Protocol data packets (e.g., as pcap files).

The method 850 may include training, via one or more processors, a machine learning model to generate realistic Internet Protocol data packets by processing the historical Internet Protocol data packets (block 856). In some aspects, training the machine learning model to generate the realistic Internet Protocol data packets by processing the historical Internet Protocol data packets includes training the machine learning model to generate data packets corresponding to a brute-force dictionary attack. In some aspects, training the machine learning model to generate the realistic Internet Protocol data packets by processing the historical Internet Protocol data packets includes training the machine learning model to generate realistic data packets corresponding to a directory search attack. In some aspects, training the machine learning model to generate the realistic Internet Protocol data packets by processing the historical Internet Protocol data packets includes training the machine learning model to generate realistic data packets corresponding to an industrial control system attack. In some aspects, the machine learning model is a generative adversarial network. Generative adversarial networks are networks wherein the training process includes providing the network receiving a mix of real or ground truth data (e.g., data packets involved with an attack) and random data as training inputs. Of course, this ground truth training data could be the data packets stored above. During training, the model learns to generate realistic examples (i.e., convincing forgeries) based on the training data.

The method 850 may include providing, via an electronic network, the generated realistic Internet Protocol data packets to an emulated networking environment used for cyberwarfare training (block 858). For example, a C programming library may be used to construct and send data packets via TCP, UDP, multicast, etc.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112 (f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one aspect” or “an aspect” means that a particular element, feature, structure, or characteristic described in connection with the aspect is included in at least one aspect. The appearances of the phrase “in one aspect” in various places in the specification are not necessarily all referring to the same aspect.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the aspects herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular aspects and applications have been illustrated and described, it is to be understood that the disclosed aspects are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computer-implemented method of generating an emulated networking environment for improved cyberwarfare training realism using machine learning, the method comprising:
receiving, via one or more processors, historical Internet Protocol packet data;
processing the historical Internet Protocol Packet data using a trained machine learning model to generate an emulated networking environment including a plurality of virtual machines, wherein the plurality of virtual machines includes 1) at least one attacker virtual machine, 2) at least one hop virtual machine; and 3) at least one target virtual machine, and wherein each of the respective plurality of virtual machines is connected to at least one other of the plurality of virtual machines via a virtual switch; and
causing the plurality of virtual machines to be instantiated.

2. The computer-implemented method of claim 1, further comprising:
generating the plurality of virtual machines, wherein the generating includes installing one or more scripts in at least one of the plurality of virtual machines.

3. The computer-implemented method of claim 1, further comprising:
generating the plurality of virtual machines, wherein the generating includes storing one or more wordlists in at least one of the plurality of virtual machines.

4. The computer-implemented method of claim 3, wherein the wordlists include a privileged user dictionary and a non-privileged user dictionary.

5. The computer-implemented method of claim 1, further comprising:
generating the plurality of virtual machines, wherein the generating includes storing at least one of 1) a brute-force attack script, 2) a side-channel attack script, 3) a power-up attack script, 4) a power-down attack script, or 5) a web automation attack script in at least one of the virtual machines.

6. The computer-implemented method of claim 1, further comprising:
receiving, from the plurality of virtual machines, one or more Internet Protocol data packets; and storing, via one or more processors, the packets in an electronic database.

7. The computer-implemented method of claim 1, further comprising:
generating the plurality of virtual machines, wherein the generating includes storing instructions for modifying an industrial control system in at least one of the plurality of virtual machines.

8. A computing system for improved cyberwarfare training realism using machine learning, comprising:
one or more processors; and
one or more memories having stored thereon computer-executable instructions that, when executed by the one or more processors, cause the computing system to:
receive historical Internet Protocol packet data;
process the historical Internet Protocol Packet data using a trained machine learning model to generate an emulated networking environment including a plurality of virtual machines, wherein the plurality of virtual machines includes 1) at least one attacker virtual machine, 2) at least one hop virtual machine; and 3) at least one target virtual machine, and wherein each of the respective plurality of virtual machines is connected to at least one other of the plurality of virtual machines via a virtual switch; and
cause the plurality of virtual machines to be instantiated.

9. The computing system of claim 8, the one or more memories having stored thereon computer-executable instructions that, when executed by the one or more processors, cause the computing system to:
install one or more scripts in at least one of the plurality of virtual machines.

10. The computing system of claim 8, the one or more memories having stored thereon computer-executable instructions that, when executed by the one or more processors, cause the computing system to:
store one or more wordlists in at least one of the plurality of virtual machines.

11. The computing system of claim 10, wherein the wordlists include a privileged user dictionary and a non-privileged user dictionary.

12. The computing system of claim 8, the one or more memories having stored thereon computer-executable instructions that, when executed by the one or more processors, cause the computing system to:
store at least one of 1) a brute-force attack script, 2) a side-channel attack script, 3) a power-up attack script, 4) a power-down attack script, or 5) a web automation attack script in at least one of the virtual machines.

13. The computing system of claim 8, the one or more memories having stored thereon computer-executable instructions that, when executed by the one or more processors, cause the computing system to:
receive, from the plurality of virtual machines, one or more Internet Protocol data packets; and store the packets in an electronic database.

14. The computing system of claim 8, the one or more memories having stored thereon computer-executable instructions that, when executed by the one or more processors, cause the computing system to:
store instructions for modifying an industrial control system in at least one of the plurality of virtual machines.

15. A non-transitory computer-readable medium having stored thereon computer-executable instructions that, when executed by the one or more processors, cause a computer to:
receive historical Internet Protocol packet data;
process the historical Internet Protocol Packet data using a trained machine learning model to generate an emulated networking environment including a plurality of virtual machines, wherein the plurality of virtual machines includes 1) at least one attacker virtual machine, 2) at least one hop virtual machine; and 3) at least one target virtual machine, and wherein each of the respective plurality of virtual machines is connected to at least one other of the plurality of virtual machines via a virtual switch; and
cause the plurality of virtual machines to be instantiated.

16. The non-transitory computer-readable medium of claim 15, having stored thereon computer-executable instructions that, when executed by the one or more processors, cause a computer to:
install one or more scripts in at least one of the plurality of virtual machines.

17. The non-transitory computer-readable medium of claim 15, having stored thereon computer-executable instructions that, when executed by the one or more processors, cause a computer to:
store one or more wordlists in at least one of the plurality of virtual machines.

18. The non-transitory computer-readable medium of claim 15, having stored thereon computer-executable instructions that, when executed by the one or more processors, cause a computer to:
store at least one of 1) a brute-force attack script, 2) a side-channel attack script, 3) a power-up attack script, 4) a power-down attack script, or 5) a web automation attack script in at least one of the virtual machines.

19. The non-transitory computer-readable medium of claim 15, having stored thereon computer-executable instructions that, when executed by the one or more processors, cause a computer to:
receive, from the plurality of virtual machines, one or more Internet Protocol data packets; and store the packets in an electronic database.

20. The non-transitory computer-readable medium of claim 15, having stored thereon computer-executable instructions that, when executed by the one or more processors, cause a computer to:
store instructions for modifying an industrial control system in at least one of the plurality of virtual machines.
